(19) United States
(12) Patent Application Publication
(10) Pub. No.: US 2003/0008759 A1
(43) Pub. Date: Jan. 9, 2003

(54) Glasses and methods for producing glasses with reduced solar transmission

(76) Inventors: Darryl J. Costin, Swiss Lake Village, OH (US); Russell D. Blume, Columbus, OH (US); Charles H. Drummond III, Columbus, OH (US); Harold S. Haller, Bay Village, OH (US); Clarence H. Martin, Gahanna, OH (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/099,448

(22) Filed: Mar. 15, 2002

Related U.S. Application Data
(63) Continuation of application No. PCT/US01/28543, filed on Sep. 11, 2001.
(60) Provisional application No. 60/232,787, filed on Sep. 15, 2000.

(51) Int. Cl. C03C 1/00; C03C 14/00; C03C 3/087

(52) U.S. Cl. 501/32; 501/71; 501/70

(57) ABSTRACT

The invention relates to modeling and other techniques which can be used to find specified interactions among components used to make a glass which can produce specified characteristics of the resulting glass material. Other aspects of the invention relate to specified materials and material combinations in glasses that produce specified results. The materials which are used may interact with one another to produce effects that are based on the interaction with the other materials. One aspect defines a glass which has a solar transmission of less than 40% for a glass less than 4 mm, with a 70% visible transmission. Another aspect teaches a solar control glass with a visible transmission of less than 25% and a solar transmission of less than 15%.

The present application claims benefit of U.S. Provisional Application No. 60/232,787, filed Sep. 15, 2000.

### BACKGROUND

Glass used in automobiles, trucks, houses and commercial buildings have different requirements for visible transmissions. For example, the specification for visible transmission for cars is 70% in the United States, whereas the visible transmission for glass used in trucks and vans behind the driver (or B pillar) is typically about 20%. The visible transmission for glass used in houses is about 70-80% and the visible transmission for glass used in buildings is generally from 20-40%. Moreover, each different kind of glass may have a different thickness. The thickness of the glass may also effect the way that it passes light.

There also may be a need to reduce the solar transmission for the glass used in each application. Glasses with reduced solar transmission used in autos and trucks provide improved passenger comfort, reduced air conditioning loads and thus improved economy. Further reduced solar and UV transmission glasses reduce the degradation of the seating and interior components of the vehicles. Likewise, glasses with reduced solar transmission used in houses and buildings may provide for reduced energy costs associated with air conditioning and reduced degradation of the draperies and furniture.

Hence, there may be advantages in reducing the solar transmission in glass used in all these applications. Techniques have been used to reduce the solar transmission in glass. The chemistry of the glass can be altered. Alternatively, a chemical vapor deposition or physical vapor deposition coatings on the glass can be added to change the transmission characteristic of the glass.

The prior art has been limited in the amount of solar transmission reduction that can actually occur to the glass by changing the chemical ingredients. However, coatings can often double or triple the cost of the glass product.

Many automotive glasses today have solar transmissions greater than 40%. For example, PPG's Solargreen Automotive Glass has a solar transmission of 45% and light transmission of 72%. Similarly, one of the best solar control glasses for vans and trucks (behind the B pillar) is PPG's GL-20 glass product with a visible transmission of 24% and a solar transmission of 23%.

The solar transmission reduction of glass may be limited by the need to achieve a specified amount of visible light transmission, e.g. 70%, since significant solar energy lies within the visible spectrum.

### SUMMARY

The inventors realized that although the visible transmission requirement is a limitation, current solar transmission levels, e.g., 40%, are far from the theoretical limit of solar blocking.

The present system teaches modeling and other techniques which can be used to find specified interactions among components which can produce specified characteristics of the resulting glass material.

Other aspects teach specified materials and material combinations that produce specified results. The materials which are used may interact with one another to produce effects that are based on the interaction with the other materials.

One aspect defines a glass which has a solar transmission of less than 40%, more preferably 35%, even more preferably 30%, even more preferably 25%, even more preferably 20%, and under perhaps ideal situations, of 15% or less for a glass less than 4 mm, e.g. a 3.3 mm glass, with a 70% visible transmission.

Another aspect teaches a solar control glass with a visible transmission of less than 25% and a solar transmission of less than 15%, more preferably 10%, and ideally less than 5%, e.g less than 4%.

Other aspects are described herein.

As described herein, novel techniques to develop glasses based on glass batch modifications with a reduction in solar transmission are disclosed.

### BRIEF DESCRIPTION OF THE DRAWINGS

These and other aspects of the invention will be described in detail with reference to the accompanying drawings, wherein:

FIG. 1 shows a graph of weighting coefficients for solar and visible transmittances;

FIG. 2 shows a graph of theoretical minimum solar transmittance as a function of visible transmittance;

FIG. 3 shows a graph of predicted solar transmittance vs. actual solar transmittance;

FIG. 4 shows a graph of predicted visible transmittance vs. actual visible transmittance;

FIG. 5 shows a graph of predicted SV T. as compared to actual SV T.;

FIG. 6 shows a graph of predicted SIR vs. the actual SIR;

FIG. 7 shows a graph of calculated and actual transmittance curves for base glass;

FIGS. 8-11 show graphs of calculated and actual transmittance curves for specified glasses; and

FIG. 12 shows a flowchart of operations for formation of the glass.

### DETAILED DESCRIPTION

The present invention describes glasses for any application, including automotive, van and truck, residential and commercial building applications. The disclosed glasses may have improved properties, including improved properties of solar transmission. The disclosed mode obtains these properties based on modifications to the glass batch chemistry.

The glass may include a glass matrix of a conventional type, e.g., formed of silicate glass, which may include soda (Na₂O)-lime (CaO)-silicate (SiO₂) glasses as SiO₂, Na₂O and CaO as the majority glass constituents. A typical soda-lime-silicate glass composition may be 72.7% SiO₂, 14.2% Na₂O, 10.0% CaO, 2.5% MgO, 0.6% Al₂O₃ with 0.3 wt % Na₂SO₄ added to the batch as a fining agent. Na₂O can be substituted to a limited extent by K₂O. MgO can increase at the expense of CaO depending on the source of raw materials utilized in the batch. The indicated nominal composition can vary±10 wt % for the majority constituents (SiO₂, Na₂O, and CaO) and still be broadly defined as a soda-lime-silicate glass.

Another aspect defines a new way to determine optimum contents of glass solutions by which enhanced solar-optical properties can be realized. A technique of forming glasses with enhanced solar control properties is described which uses computer-based design to determine complex interactions among a wide variety of glass dopants. Another aspect defines selection of dopants for functionality in solar control glasses based on the predictions of theoretical models which establish a transmittance curve which balance between solar and visible transmittance, as described herein.

“Visible” transmittance describes how much light the eye will see. This depends on a number of factors, including the “visible” sensitivity of the human eye, the characteristics of the glass, and the characteristics of the light. The eye's sensitivity can be described by weighting coefficients, as described in ASTM E 308. In contrast, different weighting factors; factors that have nothing at all to do with the sensitivity of the human eye, relate the intensity of solar radiation within the solar spectrum. Solar weighting factors depend only on the solar energy and the glass passing the radiation.

The two different sets of weighting coefficients: the visible coefficients and the solar coefficients, peak at different wavelengths. Hence, it is noted by the inventors that there need not be a one-to-one correspondence between solar and visible transmittances for the materials described herein.

According to one aspect, an ideal transmission curve is determined. This ideal transmission curve shows the lowest theoretical solar transmission at any arbitrary visible transmittance. Hence, by specifying any visible transmittance, the minimum theoretical solar transmission can be determined from this curve. An aspect of the present application produces a glass that has characteristics within a specified percentage of the theoretical minimum.

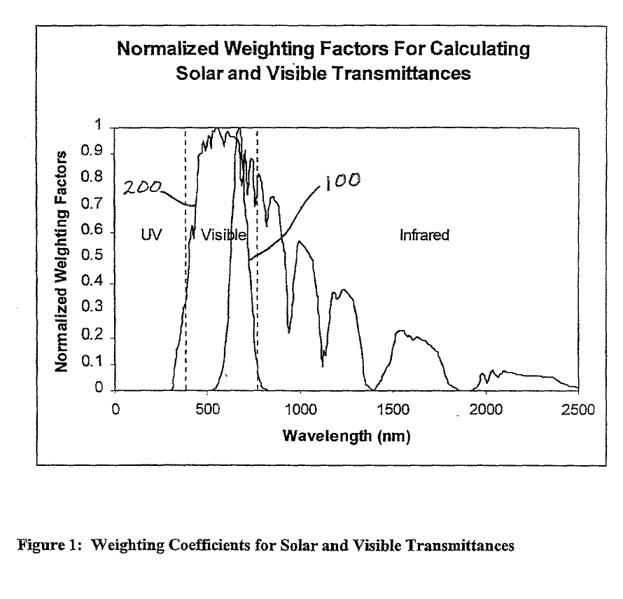

FIG. 1 illustrates the graphs of weighting coefficients for visible and solar transmittances. The visible weighting coefficients are shown as curve 100. They generally peak at around 600 nm, and form a narrow e.g. 200 nm band around the center peak. Solar weighting coefficients, shown as curve 200, in contrast, peak at around 500 nm, and may have subpeaks in other bands, extending to 1800 nm and upwards.

Another aspect relates to the transmission curves for a specified glass product. These curves are typically continuous and piecewise differentiable, e.g., they look like a group of Gaussians. Those transmission curves that obey these constraints may be the most physically meaningful.

Accepting this constraint, any arbitrary transmission curve obeying the aforementioned constraints can be obtained by a superposition of Gaussian lineshapes of the form:

$$T ( λ ) = {\sum }_{i = 1}^{n} {a}_{i} exp [ - \frac{{( λ - {X}_{i} )}^{2}}{2 {σ}_{i}^{2}} ]$$

where aᵢ represents the weighting of each Gaussian, xᵢ represents the wavelength at which the Gaussian is centered, and σᵢ represents the variance of the Gaussian lineshapee The sigma is preferably between 4.39 and 89.41. The weighting factors for visible and solar transmittance are used to find an “ideal” balance between visible and solar transmittance. This is produced by a single Gaussian of the form:

$$T ( λ ) = exp [ - \frac{{( z - λ )}^{2}}{2 * {42.59}^{2}} ]$$

where z is a value between 557.49 and 571, more preferably between 557.49 and 569.72, even more preferably 569.7 or 569.72, where the wavelength is expressed in nm. Such a solution results in 70% visible transmittance at a solar transmittance of 14.38%.

The solution represents the color L*,a*,b*=86.9968, −12.1455, 95.9363 with chromaticity coordinates of x, y=0.4972, 0.4862. This solution may be co-linear to the line connecting illuminate A (x, y=0.4512, 0.4059), and the chromaticity coordinates representing the pure spectral frequency of 569.7 nm (x, y=0.4972, 0.4862) with an r²=0.9999. For visible transmittances between 90% and 70%, the chromaticity coordinates of the optimum solutions are also on the line connecting illuminate-A and the pure spectral frequency of 569.7 nm with excitation purities of 47.6%, 66.7%, 81.5%, 92.2% for visible transmittances of 90%, 85%, 80%, and 75% respectively.

This finding can be justified in light of the trade-offs which occur between visible transmittance and solar transmittance with decreased solar transmittance requiring Gaussian solutions with low sigmas shifted to shorter wavelengths where the solar irradiance is decreased while high visible transmittances require Gaussian solutions peaked in the region where the human eyes is most sensitive and the intensity of the light source is at a maximum (570 nm) with increasing values of sigma.

With decreasing visible transmittances, a reduced sigma value in the distribution allows for only a relatively narrow band of visible light to pass through the glass. This may satisfy the constraint on total visible transmittance while minimizing solar transmittance.

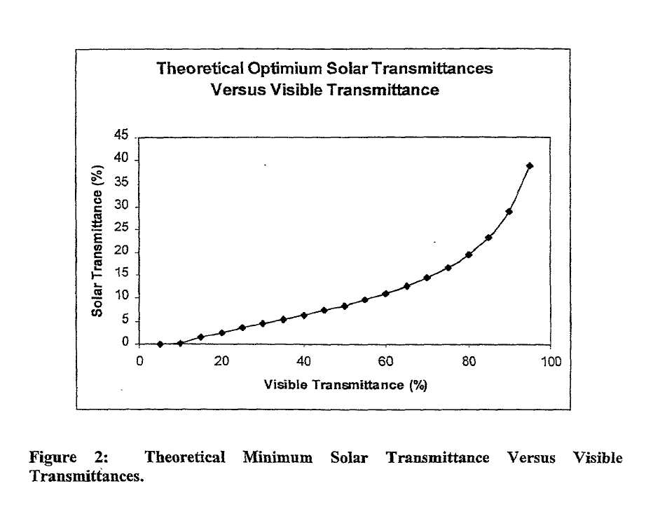

FIG. 2 summarizes the theoretical minimum solar transmittances as a function of visible transmittances while Table 1 summarizes the relevant solar control properties of these ideal solutions. According to the present system, a glass may be made relative to these ideal characteristics, e.g., a glass which is within 10% of ideal, more preferably within 7.5% of ideal, even more preferably within 5% of ideal, even most preferably within 2.5% of ideal.

TABLE 1

| | | Mean | Sigma | | | | | |
|---|---|---|---|---|---|---|---|---|
| VT (%) | ST (%) | (nm) | (nm) | L | a | b | x | y |
| 90 | 29.01 | 568.07 | 89.41 | 96.00 | −6.43 | 36.95 | 0.4737 | 0.4437 |
| 85 | 23.34 | 568.98 | 69.88 | 93.88 | −8.31 | 54.66 | 0.4833 | 0.4586 |
| 80 | 19.49 | 569.47 | 57.78 | 91.68 | −9.74 | 70.66 | 0.4904 | 0.4702 |
| 75 | 16.63 | 569.69 | 49.19 | 89.39 | −10.97 | 84.51 | 0.4950 | 0.4792 |
| 70 | 14.38 | 569.72 | 42.59 | 87.00 | −12.15 | 95.94 | 0.4972 | 0.4862 |
| 65 | 12.53 | 569.60 | 37.23 | 84.48 | −13.41 | 104.84 | 0.4975 | 0.4919 |
| 60 | 10.96 | 569.34 | 32.71 | 81.84 | −14.86 | 111.25 | 0.4961 | 0.4970 |
| 55 | 9.59 | 568.93 | 28.80 | 79.04 | −16.61 | 115.31 | 0.4931 | 0.5023 |
| 50 | 8.38 | 568.31 | 25.32 | 76.07 | −18.82 | 117.28 | 0.4884 | 0.5084 |
| 45 | 7.29 | 567.37 | 22.19 | 72.89 | −21.73 | 117.37 | 0.4815 | 0.5162 |
| 40 | 6.28 | 565.96 | 19.32 | 69.47 | −25.67 | 115.73 | 0.4714 | 0.5268 |
| 35 | 5.33 | 563.88 | 16.67 | 65.75 | −30.99 | 112.32 | 0.4567 | 0.5417 |
| 30 | 4.43 | 561.22 | 14.20 | 61.65 | −37.26 | 107.22 | 0.4375 | 0.5609 |
| 25 | 3.51 | 558.70 | 11.82 | 57.08 | −42.38 | 101.13 | 0.4181 | 0.5803 |
| 20 | 2.54 | 557.49 | 9.42 | 51.84 | −43.45 | 95.16 | 0.4063 | 0.5923 |
| 15 | 1.47 | 558.04 | 6.98 | 45.63 | −39.55 | 89.39 | 0.4063 | 0.5929 |
| 10 | 0.31 | 559.58 | 4.39 | 37.84 | −32.56 | 83.19 | 0.4138 | 0.5859 |

Summary of Solar Control Properties of Optimized Solar Control Glasses

Computer-designed experimental methods may be used with multiple correlation analysis according to the present system, to form improved glasses, with reduced solar transmission. In order to optimize a glass composition to achieve minimum solar transmission for given other constraints, mathematical models of the relationship between the visible and solar transmission and the glass elemental constituents may be used. These models also account for interactive effects between the various compounds in the glass batch. The inventors believe that the best commercially available glasses have greater solar transmission than the ideal glass, because interactive effects among the various compounds in the glass have not been adequately taken into consideration. These interactive effects may have the most influence on reducing solar transmission in glass. The inventors also believe that some of the compounds and the interactivity of the compounds in the glass contribute to the infrared absorption at different wavelengths. Hence, the mathematical models explained herein not only account for the interactive effects of the glass constituents, but also account for the model response of the solar transmission at individual wavelengths vs. the conventional methodology of integrating the solar transmission across the range of wavelength 380-2500 nm.

It is found that attention to theoretical limitations of optimum solar control properties may improve the development of improved solar control glasses. Furthermore, due to the distribution of the weighting coefficients for solar and visible transmittance, there need not be a one-to-one correspondence between solar and visible transmittances. In particular, the realization of the ideal transmission curve allows for high visible transmittance with lower solar transmittance.

Interactions among the dopants, in fact, may be as important as the dopants themselves.

The glass may include primary dopants, which can include FeₓO_{y}, e.g., Fe₂O₃, NiO, CoO, and V₂O₅. Reducing agents such as SnO, C, and metal sulfides may also be added. The first kind of interaction may include redox interactions among the primary dopants and the reducing agents. Some dopants may exist in multiple valence states. Another interaction may cause one or more of these dopants to exist in a specified valence state, in order to tailor the dopant's properties based on the properties of that valence state. Examples are described herein, in which the presence of dopant B causes dopant A to exist in a specified valence state.

An important interaction causes decolorization of primary dopants (e.g. Fe₂O₃) in the visible spectrum by the addition of dopants, such as fluorine and P₂O₅.

The absorption spectrum may be shifted by incorporation of high field strength cations (TiO₂) and the associated weakening in the metal-ligand bonds of the primary dopants.

Optical clarification effects may also be caused, e.g., by ZnO additions. These additions may prevent formation of other materials, such as strongly colored metal sulfides (FeS, NiS).

Infrared absorption of ferrous iron may be enhanced by P₂O₅ additions.

The model to determine glasses with various characteristics may follow the flowchart of FIG. 12. Fractional or factorial experimental design may be a preferred method of experimental investigations. In order to address the limitations of fractional factorial design strategies, computer assisted, D-optimal design of experiments may be used at 1100 to efficiently model complex interactions among a large number of compositional variables. A large number of independent variables and interaction terms are considered. The analysis may use a computer assisted design of experiment (DOE) software package licensed to Harold S. Haller Inc., known as HITS (Haller Information Technology Software). The Experimental Design Optimization module of the HITS software package is based on the so called D-optimal or |X^{T}X| criterion, which maximizes the determinate of the |X^{T}X| matrix using heuristic process known as the Exchange Method. Statistical theory establishes that the least squares fit to a set of experimental data is given by:

β=(X^{T}X)⁻¹X^{T}Y

where X^{T} represents the transpose of the experimental matrix |X|, the operation (X^{T}X)⁻¹ represents the inverse matrix of the |X^{T}X|, and Y is the observation matrix. It should be noted that in order to obtain the inverse of the matrix |X^{T}X|, the determinate of the |X| matrix must be non-zero. This requirement is equivalent to stating that the matrix |X|, be of full column rank, i.e., no column vector is a linear combination of other column vectors.

When one or more column vectors in the matrix |X| is a linear combination of any other combination of column vectors, the design is less likely to extract relationships between the dependant and independent variables as specified by the model. The DOE module produces an experimental design which insures that the |X^{T}X| matrix is invertible with the minimum level of confoundance.

The error of prediction (EOP) is found at 1105. EOP at any point (xₒ) in the design space is given by the formula:

$$\frac{E O P}{σ} = \sqrt{{{x}_{0}^{T} ( {X}^{T} X )}^{- 1} {x}_{o}}$$

where σ is the experimental or testing error. If the EOP/σ is greater than 1, this indicates that additional experiments may be desirable. An EOP/σ less than one indicates that too many experiments may have been conducted. An average EOP/σ equal to 1 may represent the ideal design. Hence, the EOP is driven toward 1 at 1105. D-Optimal theory also establishes that the optimal experimental design with the lowest average EOP across the design space is the design which maximizes the determinate of the |X^{T}X| matrix.

Application of computer assisted design of experiments based on the D-optimal design criterion may produce significant advantages in the field and allow for efficient experimental methodology by which a large number of independent variables and subsequent interactions among the variables can be investigated.

Model

The inventors also recognize that solar and visible transmittances can be modeled as a linear function of glass composition.

The limitations associated with such models are based on the fact that both solar and visible transmittances are integrated quantities; that is, the values of these quantities depend upon the shape of the optical transmittance curves. The integrated nature of these response variables may be problematic in developing linear models due to the fact that in principle, there are an infinite number of transmission curves, which can result in the same value of solar or visible transmittance. The integrated nature of the response variable introduces large uncertainty as to the true relationships among the independent compositional variables and the measured response. Furthermore, a mechanistic basis for postulating a linear relationship between glass composition and visible transmittance may be difficult. The lack of such a mechanistic basis for the model may introduce further uncertainty in the predictions of the aforementioned models. The failure of previous investigators to recognize these limitations has impaired the realization of glasses with reduced solar transmissions significantly below that which is the basis for the current state of the art.

A discrete optical response of the system is modeled at 1110 at each of a plurality of wavelengths, for calculating the solar and visible transmittance. This compares with previous systems which modeled the integrated solar and visible transmittances.

A modified form of the Lambert-Beer Absorption Law is used herein as the basis for a functional form relating the transmission at each wavelength and the thickness of the glass to the glass composition:

$$- {t}^{- 1} log [ T ( λ ) ] = {\sum }_{i} {β}_{i} {c}_{i} + {\sum }_{i} {\sum }_{j} {β}_{ij} {c}_{i} {c}_{j}$$

where t is the thickness of the glass, T(λ) is the measured transmission at each wavelength, Cᵢ is the concentration of each primary dopant added to the glass, Cⱼ is the concentration of each interacive dopant added to the glass, and βᵢ and βᵢⱼ are the least squares regression coefficients.

While the Lambert-Beer law of absorption has been applied to many experimental investigations relating optical response to glass composition, this version may incorporate non-linear interaction terms. Additionally, previous investigators, recognizing that the Lambert-Beer Law of Absorption only provides acceptable correlation to optical response when the actual weight percentages in the final glass of each dopant oxide in all valence states are utilized, have developed linear models with all valance states of each dopant oxide included as linear effects. This approach has limited usefulness, despite the fact that such models fit the data well, due to the fact that the final redox state of all dopants in the glass is not easily predicted in complex glass compositions containing multiple transition metal oxides capable of existing in a variety of redox states in the glass.

The current investigators have realized that the redox state of the dopant oxides in the glass is convoluted with the optical response, and therefore, the actual redox states of the dopant oxides should not be included as linear independent variables. The inventors realized that only those variables which could readily be controlled by the experimenter; namely the weight percentages of the batched dopants, should properly be utilized as independent variables. This is shown as 1115.

Changes in redox state upon melting are properly modeled as interactions among the batched dopants. Utilization of a modified Lambert-beer law of absorption whereby the weight percentages of the batched dopants are utilized as linearly independent variables with changes in redox state of the batched dopants accounted for by non-linear interactions among the dopants may also produce advantages in the modeling of solar control properties of glasses.

This design methodology and model form allows for control and optimization of product coloration, in addition to the control and optimization of solar control properties. The discrete response of the system is modeled at each of a plurality of wavelengths necessary for the calculation of solar and visible transmittances. Transmittance curves as a function of batch composition can be calculated from which color coordinates (L, a*, b*, x, y) can be derived. 1120 represents product coloration to be incorporated as a constraint in the development of solar control properties.

Model Results:

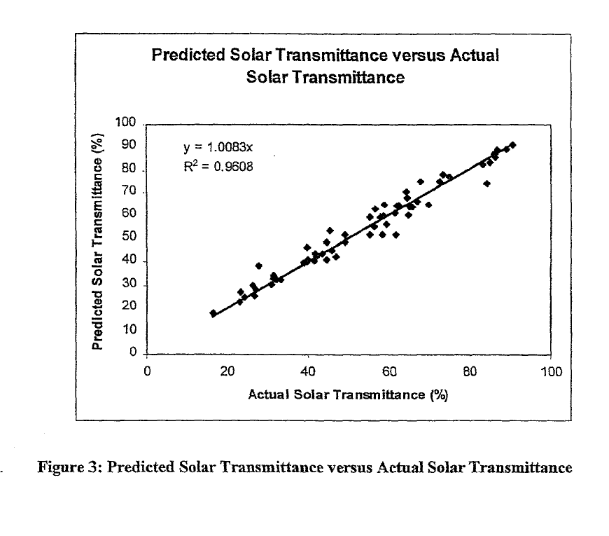

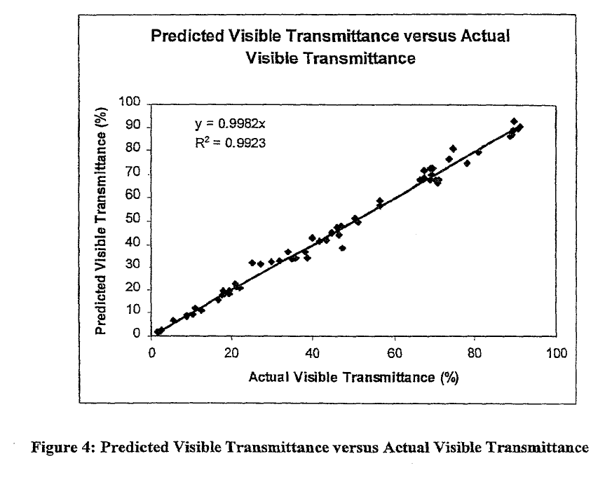

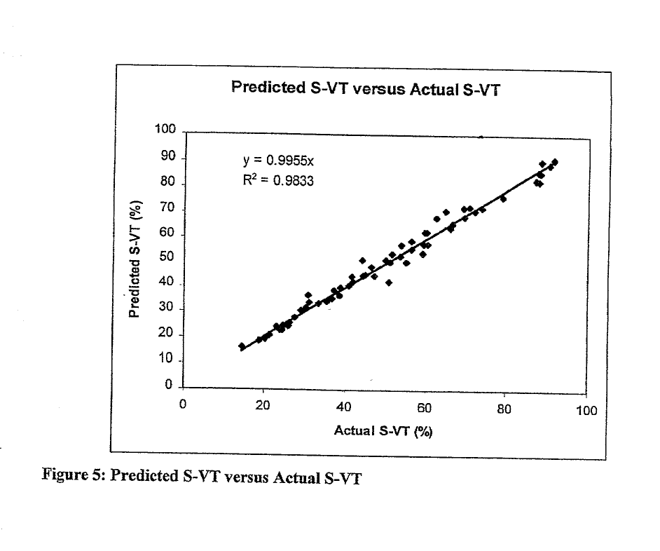

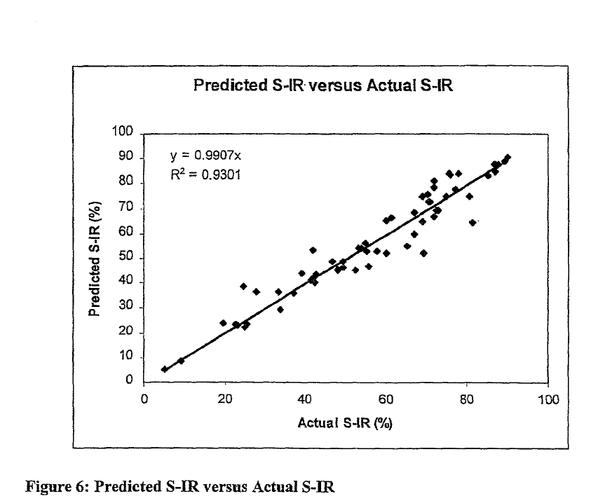

Utilizing the aforementioned design methodology, 64 experimental glass compositions were generated from the computerized design of experiments program. The compositions of these glasses are summarized in Table 2. As is evident upon inspection of Table 2, both the number of dopants and the compositional ranges of the dopants utilized in the current investigation explore a much wider range of compositions compared to previous investigations. Table 3 summarizes the measured and calculated solar control properties for the glasses examined in the course of this investigation. As can be seen by inspection of Table 3 and of FIGS. 3-6 the agreement of the model to the measured data is exceptional.

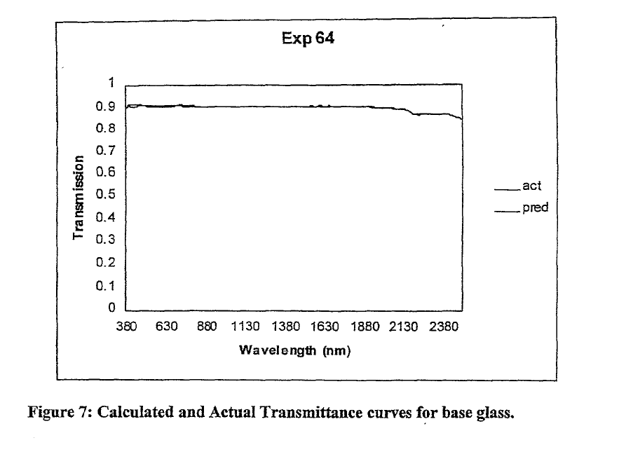

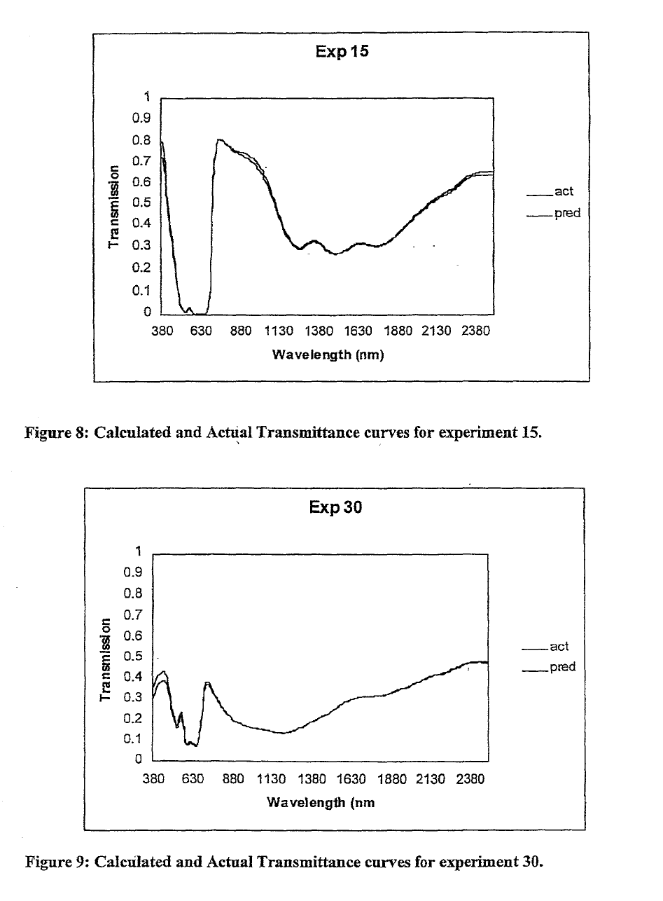

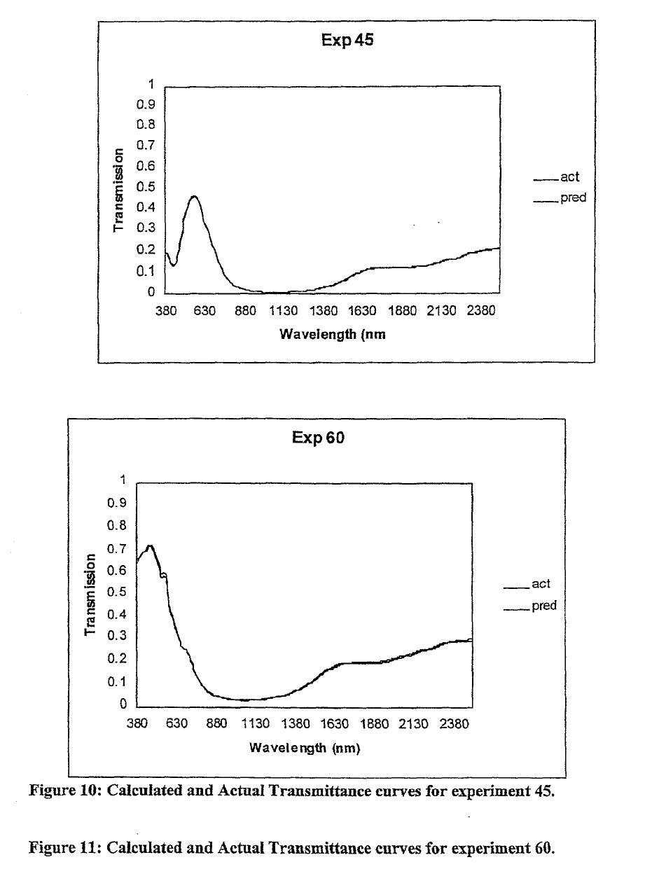

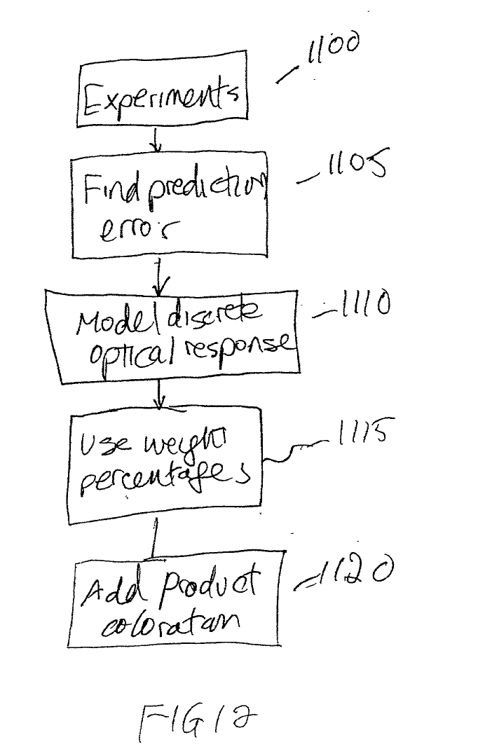

FIGS. 7-11 illustrate the ability of the model in predicting the solar control properties for selected melts utilizing the aforementioned methodology.

TABLE 2

| | Fe₂O₃ | NiO | CaF₂ | P₂O₅ | TiO₂ | CoO | V₂O₅ | ZnS | ZnO | SnO |
|---|---|---|---|---|---|---|---|---|---|---|
| 1 | 0 | 0 | 1 | 2 | 1.5 | 0 | 0.225 | 0.1 | 2 | 3 |
| 2 | 0.3 | 0.05 | 2 | 2 | 1.5 | 0 | 0 | 0.1 | 2 | 3 |
| 3 | 0.3 | 0 | 1 | 0.5 | 0.5 | 0.05 | 0.05 | 0.1 | 2 | 1 |
| 4 | 0 | 0 | 2 | 0.5 | 1.5 | 0 | 0.225 | 0.1 | 0.5 | 1 |
| 5 | 0.1 | 0 | 0 | 0.5 | 1.5 | 0.15 | 0.05 | 0.1 | 0.5 | 3 |
| 6 | 0.1 | 0.05 | 0 | 2 | 0.5 | 0.15 | 0 | 0.1 | 2 | 1 |
| 7 | 0.3 | 0 | 0 | 0 | 1.5 | 0 | 0 | 0.03 | 2 | 1 |
| 8 | 0 | 0.15 | 2 | 0 | 0.5 | 0 | 0.05 | 0.06 | 1 | 3 |
| 9 | 0 | 0.10 | 0 | 1 | 1.5 | 0.05 | 0.125 | 0.03 | 2 | 2 |
| 10 | 0 | 0 | 0 | 2 | 0 | 0 | 0.225 | 0.06 | 1 | 0 |
| 11 | 0 | 0 | 2 | 0 | 1.5 | 0.15 | 0.05 | 0 | 2 | 0 |
| 12 | 0.1 | 0.15 | 1 | 2 | 0 | 0 | 0.05 | 0 | 1 | 2 |
| 13 | 0.2 | 0.05 | 1 | 2 | 1 | 0 | 0.125 | 0.06 | 0 | 0 |
| 14 | 0.1 | 0 | 1 | 0 | 0 | 0.05 | 0 | 0.06 | 2 | 3 |
| 15 | 0 | 0.05 | 1 | 1 | 1 | 0.15 | 0 | 0.06 | 1 | 3 |
| 16 | 0 | 0.05 | 2 | 2 | 0 | 0.15 | 0.05 | 0.06 | 0 | 2 |
| 17 | 0.3 | 0.05 | 2 | 1 | 0 | 0.05 | 0 | 0 | 1 | 0 |
| 18 | 0 | 0 | 0 | 2 | 1 | 0.05 | 0 | 0 | 1 | 2 |
| 19 | 0.1 | 0 | 2 | 1 | 1 | 0 | 0 | 0 | 2 | 0 |
| 20 | 0.1 | 0.05 | 2 | 0 | 1.5 | 0.05 | 0.125 | 0 | 0 | 3 |
| 21 | 0 | 0.05 | 1 | 0 | 1.5 | 0 | 0 | 0.1 | 1 | 1 |
| 22 | 0 | 0 | 0 | 1 | 0 | 0 | 0.05 | 0.1 | 0 | 0 |
| 23 | 0 | 0.15 | 2 | 0 | 1 | 0.05 | 0 | 0.1 | 0 | 1 |
| 24 | 0.1 | 0 | 2 | 2 | 1.5 | 0.05 | 0.05 | 0.06 | 1 | 2 |
| 25 | 0.1 | 0.15 | 1 | 1 | 1.5 | 0.05 | 0 | 0.03 | 0 | 0 |
| 26 | 0.1 | 0.15 | 2 | 2 | 1.5 | 0.05 | 0 | 0.1 | 2 | 3 |
| 27 | 0 | 0 | 2 | 0 | 1.5 | 0 | .225 | 0.1 | 2 | 3 |
| 28 | 0.3 | 0.05 | 0 | 2 | 0 | 0.05 | 0 | 0.1 | 2 | 0 |
| 29 | 0.3 | 0.05 | 0 | 0 | 1.5 | 0 | 0.05 | 0.1 | 0 | 3 |
| 30 | 0.3 | 0 | 0 | 2 | 1.5 | 0.05 | 0.05 | 0 | 2 | 3 |
| 31 | 0 | 0 | 2 | 2 | 0 | 0.05 | 0 | 0.1 | 2 | 3 |
| 32 | 0.1 | 0.15 | 0 | 0 | 0 | 0.05 | 0 | 0.1 | 2 | 3 |
| 33 | 0 | 0 | 0 | 2 | 0 | 0 | 0.225 | 0.1 | 2 | 0 |
| 34 | 0.1 | 0.15 | 0 | 2 | 1.5 | 0 | 0 | 0 | 2 | 3 |
| 35 | 0.1 | 0.15 | 0 | 2 | 0 | 0 | 0.05 | 0.1 | 0 | 0 |
| 36 | 0 | 0 | 0 | 2 | 1.5 | 0 | 0.225 | 0 | 2 | 3 |
| 37 | 0 | 0 | 2 | 2 | 1.5 | 0 | 0.225 | 0 | 2 | 0 |
| 38 | 0.2 | 0.15 | 2 | 0 | 1.5 | 0 | 0 | 0 | 2 | 0 |
| 39 | 0 | 0 | 0 | 2 | 1.5 | 0.03 | 0 | 0.1 | 0 | 0 |
| 40 | 0.2 | 0 | 2 | 0 | 1.5 | 0.03 | 0 | 0 | 2 | 0 |
| 41 | 0 | 0 | 0 | 2 | 1.5 | 0.03 | 0 | 0 | 0 | 3 |
| 42 | 0.8 | 0 | 2 | 0 | 0 | 0 | 0 | 0 | 2 | 0 |
| 43 | 0 | 0.05 | 0 | 0 | 1.5 | 0 | 0 | 0.1 | 0 | 3 |
| 44 | 0.4 | 0.05 | 0.5 | 0 | 1.5 | 0 | 0.125 | 0 | 0 | 0 |
| 45 | 0.8 | 0.05 | 2 | 2 | 0 | 0 | 0.05 | 0 | 0 | 3 |
| 46 | 0 | 0 | 0 | 0 | 0 | 0 | 0.225 | 0 | 2 | 0 |
| 47 | 0.8 | 0 | 2 | 2 | 1.5 | 0.01 | 0.05 | 0.1 | 0 | 0 |
| 48 | 0 | 0 | 2 | 0 | 0 | 0.01 | 0 | 0 | 0 | 0 |
| 49 | 0.8 | 0 | 2 | 0 | 1.5 | 0 | 0 | 0.1 | 2 | 3 |
| 50 | 0 | 0.15 | 0 | 0 | 1.5 | 0 | 0 | 0.1 | 2 | 0 |
| 51 | 0 | 0 | 0 | 2 | 1.5 | 0.03 | 0 | 0 | 2 | 0 |
| 52 | 0.2 | 0.15 | 2 | 0 | 0 | 0 | 0.05 | 0 | 2 | 0 |
| 53 | 0 | 0.05 | 0 | 0 | 0 | 0 | 0 | 0.1 | 0 | 2 |
| 54 | 0 | 0 | 0 | 0 | 1.5 | 0 | 0.225 | 0 | 2 | 3 |
| 55 | 0.8 | 0 | 2 | 2 | 1.5 | 0 | 0 | 0 | 2 | 0 |
| 56 | 0.2 | 0.15 | 0 | 2 | 0 | 0.01 | 0 | 0.1 | 0 | 3 |
| 57 | 0 | 0.05 | 0 | 0 | 0 | 0.03 | 0 | 0 | 2 | 2 |
| 58 | 0.4 | 0.10 | 2 | 0 | 1.5 | 0.01 | 0 | 0 | 0 | 1 |
| 59 | 0 | 0 | 2 | 2 | 1.5 | 0 | 0.225 | 0 | 0 | 0 |
| 60 | 0.8 | 0 | 0 | 0 | 0 | 0.01 | 0 | 0 | 2 | 3 |
| 61 | 0 | 0.15 | 2 | 2 | 1.5 | 0 | 0 | 0 | 2 | 3 |
| 62 | 0 | 0.15 | 0 | 0 | 0 | 0.01 | 0.05 | 0 | 0 | 0 |
| 63 | 0 | 0 | 0 | 0 | 1.5 | 0.03 | 0 | 0.1 | 2 | 3 |
| 64 | 0 | 0 | 0 | 0 | 0 | 0 | 0 | 0 | 0 | 0 |

The experimental matrix utilized in the current investigation.

TABLE 3

| | act-ST | pred-ST | act-VT | pred-VT | act-S-VT | pred-S-VT | act-S-IR | pred-S-IR |
|---|---|---|---|---|---|---|---|---|
| 1 | 65.69 | 63.81 | 70.23 | 67.76 | 60.30 | 57.58 | 72.77 | 69.25 |
| 2 | 32.02 | 32.77 | 45.94 | 47.19 | 38.80 | 39.51 | 25.50 | 23.59 |
| 3 | 26.11 | 38.39 | 18.09 | 19.40 | 30.91 | 36.35 | 24.62 | 38.62 |
| 4 | 67.57 | 74.87 | 73.59 | 76.34 | 64.61 | 70.84 | 71.75 | 78.33 |
| 5 | 27.02 | 25.34 | 1.80 | 1.88 | 20.43 | 19.51 | 33.81 | 29.16 |
| 6 | 31.52 | 34.53 | 2.38 | 2.28 | 23.27 | 23.87 | 39.15 | 43.71 |
| 7 | 45.20 | 53.35 | 74.63 | 80.97 | 62.28 | 68.20 | 27.63 | 36.27 |
| 8 | 43.62 | 43.78 | 27.10 | 31.21 | 30.93 | 33.54 | 67.66 | 52.82 |
| 9 | 38.99 | 39.80 | 9.03 | 8.98 | 24.79 | 24.37 | 54.01 | 54.16 |
| 10 | 86.30 | 85.55 | 89.69 | 88.81 | 88.04 | 85.80 | 86.90 | 84.84 |
| 11 | 44.59 | 48.81 | 2.62 | 2.65 | 30.28 | 31.72 | 59.96 | 65.20 |
| 12 | 39.68 | 46.53 | 35.24 | 33.56 | 37.22 | 38.43 | 41.99 | 53.39 |
| 13 | 66.89 | 65.91 | 66.50 | 67.73 | 66.32 | 65.76 | 68.95 | 65.01 |
| 14 | 45.83 | 45.04 | 21.41 | 21.17 | 41.76 | 42.05 | 49.30 | 46.48 |
| 15 | 39.67 | 40.32 | 2.31 | 2.15 | 26.23 | 25.38 | 53.21 | 54.19 |
| 16 | 33.21 | 32.62 | 1.47 | 1.55 | 18.78 | 18.79 | 48.09 | 45.08 |
| 17 | 46.92 | 42.31 | 19.66 | 19.57 | 38.47 | 36.51 | 55.79 | 46.63 |
| 18 | 58.80 | 64.70 | 21.18 | 22.51 | 46.23 | 48.12 | 71.74 | 81.05 |
| 19 | 84.26 | 74.06 | 89.56 | 88.95 | 87.80 | 82.57 | 81.31 | 64.30 |
| 20 | 32.29 | 32.47 | 12.51 | 10.97 | 23.96 | 22.47 | 41.35 | 40.90 |
| 21 | 74.71 | 77.41 | 70.94 | 67.73 | 71.96 | 70.69 | 77.98 | 83.78 |
| 22 | 89.12 | 89.13 | 90.83 | 89.68 | 90.36 | 89.14 | 89.39 | 88.78 |
| 23 | 39.94 | 40.91 | 8.97 | 8.34 | 25.38 | 24.53 | 55.03 | 56.30 |
| 24 | 41.39 | 40.62 | 19.49 | 18.21 | 35.27 | 34.15 | 48.04 | 45.59 |
| 25 | 42.01 | 42.28 | 10.89 | 12.11 | 29.07 | 30.47 | 55.24 | 52.92 |
| 26 | 23.49 | 27.19 | 5.72 | 6.70 | 14.47 | 16.30 | 33.34 | 36.40 |
| 27 | 64.86 | 63.81 | 68.86 | 67.76 | 59.25 | 57.58 | 72.22 | 69.25 |
| 28 | 44.42 | 40.95 | 18.44 | 18.23 | 36.74 | 35.26 | 52.38 | 45.10 |
| 29 | 31.53 | 33.12 | 51.06 | 49.72 | 40.59 | 40.39 | 22.59 | 23.40 |
| 30 | 24.45 | 24.80 | 16.73 | 15.51 | 25.85 | 24.11 | 23.16 | 23.18 |
| 31 | 59.34 | 56.16 | 22.04 | 20.82 | 47.02 | 44.67 | 71.64 | 66.90 |
| 32 | 31.07 | 30.19 | 10.50 | 9.48 | 24.36 | 22.73 | 37.14 | 35.88 |
| 33 | 85.11 | 83.32 | 88.89 | 86.31 | 87.15 | 82.90 | 85.34 | 83.23 |
| 34 | 41.67 | 43.90 | 39.99 | 43.10 | 41.58 | 44.11 | 42.24 | 41.95 |
| 35 | 58.50 | 59.66 | 43.43 | 41.98 | 51.01 | 50.15 | 66.92 | 68.41 |
| 36 | 64.42 | 67.85 | 69.01 | 72.69 | 59.59 | 62.45 | 70.83 | 72.53 |
| 37 | 86.16 | 87.07 | 89.28 | 87.22 | 87.51 | 86.30 | 87.15 | 87.47 |
| 38 | 55.19 | 51.94 | 47.08 | 47.98 | 50.97 | 50.24 | 59.98 | 52.23 |
| 39 | 69.72 | 64.54 | 38.64 | 34.04 | 59.05 | 53.75 | 80.76 | 74.79 |
| 40 | 61.69 | 51.86 | 38.08 | 36.57 | 55.08 | 50.18 | 69.20 | 52.12 |
| 41 | 64.03 | 70.60 | 34.21 | 36.60 | 53.67 | 57.13 | 75.54 | 83.86 |
| 42 | 61.32 | 61.22 | 81.00 | 79.62 | 73.76 | 71.88 | 49.32 | 48.81 |
| 43 | 72.63 | 75.16 | 67.47 | 71.64 | 69.33 | 72.17 | 77.07 | 77.53 |
| 44 | 64.75 | 60.15 | 67.55 | 68.50 | 65.84 | 63.98 | 65.17 | 54.90 |
| 45 | 16.51 | 17.80 | 41.78 | 41.57 | 27.48 | 27.38 | 5.10 | 5.18 |
| 46 | 86.76 | 89.05 | 89.70 | 92.70 | 88.25 | 90.37 | 87.60 | 87.32 |
| 47 | 49.12 | 51.96 | 56.53 | 58.80 | 56.23 | 58.63 | 42.65 | 43.44 |
| 48 | 83.22 | 82.38 | 70.68 | 66.32 | 78.84 | 76.72 | 87.81 | 87.78 |
| 49 | 49.00 | 48.59 | 56.44 | 56.75 | 56.11 | 55.33 | 42.55 | 39.90 |
| 50 | 61.88 | 64.35 | 46.53 | 44.36 | 53.56 | 52.68 | 70.28 | 75.52 |
| 51 | 67.82 | 70.60 | 35.18 | 36.60 | 56.81 | 57.13 | 79.19 | 83.86 |
| 52 | 55.20 | 59.24 | 44.78 | 44.95 | 49.96 | 51.16 | 61.28 | 66.48 |
| 53 | 73.31 | 78.21 | 69.13 | 69.99 | 70.81 | 72.53 | 75.83 | 83.51 |
| 54 | 64.49 | 67.85 | 69.46 | 72.69 | 60.14 | 62.45 | 70.45 | 72.53 |
| 55 | 57.75 | 59.56 | 78.04 | 74.92 | 69.34 | 68.51 | 46.82 | 48.89 |
| 56 | 23.08 | 22.68 | 17.83 | 17.80 | 21.25 | 20.57 | 24.99 | 22.50 |
| 57 | 56.49 | 63.07 | 25.12 | 31.75 | 43.92 | 50.99 | 68.97 | 74.63 |
| 58 | 26.59 | 29.79 | 36.00 | 34.15 | 33.29 | 33.11 | 19.48 | 24.12 |
| 59 | 85.90 | 87.07 | 89.28 | 87.22 | 87.42 | 86.30 | 86.72 | 87.47 |
| 60 | 27.25 | 28.27 | 50.44 | 51.50 | 44.17 | 44.71 | 9.05 | 8.75 |
| 61 | 58.23 | 51.59 | 47.38 | 38.65 | 50.76 | 42.29 | 67.01 | 59.88 |
| 62 | 56.33 | 55.33 | 32.01 | 32.66 | 44.82 | 44.90 | 68.99 | 84.92 |
| 63 | 62.43 | 64.47 | 29.90 | 32.52 | 51.41 | 53.64 | 74.70 | 74.75 |
| 64 | 90.64 | 90.91 | 91.45 | 90.67 | 91.25 | 91.07 | 90.20 | 90.47 |

Calculated and measured solar control properties of the glasses utilized in the current investigation.

The degree of agreement between the calculated and experimental over a wide range of compositions supports the claim that the aforementioned design and modeling methodology represents significant advancement in the field. Such predictive power, based on a modified Lambert-Beer Law of absorption, which accounts for interactions among the batch components, may even further enhance solar control glasses.

The glasses formed herein have characteristics that are based on, among other things, the kind and quantity of dopants added to the glass. The glass itself may include any kind of base as matrix material, such as, for example, a silicate material.

Dopant Functionality:

Iron Oxide:

Iron oxide occurs primarily in one of its two stable valence states, Fe⁺² and Fe⁺³, in many glass matrix materials such as a soda-lime-silicate, fired under ambient to moderately reducing conditions. Ferric oxide (Fe₂O₃) may manifest absorption peaks in the ultraviolet which trails into the near-UV. This has formed a characteristic straw-yellow color to soda-lime-silicate glasses doped with Fe⁺³. At times, this yellow color may give the glass a weathered look, and glass of this color has not been well accepted by many customers.

Ferric iron can occur in a coordination of both four (tetrahedral) and six (octahedral) in glass depending on the basicity of the host matrix with tetrahedral coordination dominating in alkali-silicate glasses. Ferric iron in its octahedral coordination has only been observed in highly acidic glasses such as Fe⁺³ doped vitreous silica, phosphate and borate glasses. Octahedrally coordinated Fe⁺³ manifests no absorption bands in the visible while tetrahedral coordinated Fe⁺³ manifest absorption bands at 380, 425 and 440 nm. Ferrous oxide (FeO) manifests absorption bands in the visible and near-IR in broadband at 1-1.1 μm and 2.6-5.0 μm. Fe⁺² usually occurs in its octahedral coordination in glass over a wide range of glass basicity. Fe⁺² exhibits intense IR-absorption in the near-IR making this dopant ideal for achieving a substantial reduction in total solar transmittance, with an especially strong reduction in solar-IR.

Iron oxide in glass can exist in one of 3 forms as free metal (Fe⁰), ferrous oxide (FeO) or as ferric oxide (Fe₂O₃) depending on how reducing (SnO, ZnS additions to the glass) the glass is. This reduction state may be based on the amount of SnO and ZnS additions to the glass, for example. In order to understand the difference between these three forms one has to understand two rules: atoms and ions want to be electrically neutral (that is they have the same number of electrons as protons), and they would like to have a filled outer shell of electrons. The metal iron is electrically neutral and has as many electrons circling the nucleus as it has protons in the nucleus and therefore is denoted with the symbol Fe⁰ where the superscript indicates the charge on the atom as zero. An oxygen ion has 6 electrons in its outer shell and would like to acquire a total of 2 electrons from other atoms if possible to fill its outer shell. If it is successful in doing this it will now have a charge of −2 (O²⁻) due to these excess electrons. If iron metal comes in contact with an oxygen molecule (O₂) the following reaction will occur in which two electrons are ripped from each iron atom (this is called oxidation) and become associated with each O atom (this is called reduction). This process results in the neutral iron becoming a positively charged ion (Fe⁺²) and the neutral oxygen molecule being transformed into two negatively charged oxide anions (O²⁻).

2Fe^{o}+O₂→2FeO

FeO can then react with oxygen as shown in the following reaction to form ferric oxide (Fe₂O₃) whereby an additional electron is ripped from each Fe⁺² forming Fe⁺³.

2FeO+½O₂→Fe₂O₃

These reactions are reversible and are termed oxidation-reduction reactions. Once the positively charged Fe⁺² and Fe⁺³ cations are formed, they are no longer electrically neutral and must have their charge neutralized by being surrounded by negatively charged O²⁻ ions. Through these reactions, oxygen gains the two electrons it needs to fully occupy its outer shell. Although the occupancy of Fe⁺² and Fe⁺³ are too complicated to describe here, they too are stable with the transfer of electrons. So the bottom line is that iron oxide can exist in a variety of forms in the glass and ferrous iron refers to a Fe⁺² ions which is formed when the neutral Fe atom loses two electrons to an oxygen atom while ferric iron refers to a Fe⁺³ ion which has lost an additional electron to oxygen atoms. Rather than expressing the concentration of Fe⁺² and Fe⁺³ in the glass, the amounts are given as wt % FeO and Fe₂O₃ to indicate that these ions are associated with oxide (O²⁻) ions to get charge neutralization. In a real glass there is a distribution between Fe⁺² and Fe⁺³ with oxidizing conditions favoring Fe⁺³ and reducing conditions favoring Fe⁺².

Iron doped glasses fired under ambient conditions of oxygen fugacity typically manifest a transmission maxima in the visible centered at 550 nm. This imparts a characteristic yellow-green color to iron doped soda-lime-silicate glasses. The occurrence of the transmission maxima is in the vicinity of a maximum transmission of the theoretically optimal solution for solar control glasses. Fe⁺² also absorbs in the near-IR. This makes iron oxide a useful important component of solar control glasses.

Iron in the presence of sulfate (SO₃) in glasses, under narrow ranges of oxygen fugacities where both ferrous and ferric iron are present in combination with both sulfate and sulfide (S⁻²) can form an intensely absorbing chromophore with an absorption band at 410-500 nm which imparts an amber-brown coloration to silicate glasses. This chromophore is believed to involve a tetrahedrally coordinated Fe⁺³ with one of the four oxygens substituted by a sulfate group linked to a Fe⁺² cation in octahedral coordination, with one of the 6 oxygens substituted by a sulfide anion.

Formation of such a chromaphore may be detrimental to the achievement of solar control glasses with commercially desirable product colorations. Both the amber and the yellow glasses may be commercially undesirable. To this end, compositional modifications to the host glass, which inhibits formation of this chromophore, may enhance the look of solar control glasses.

Both the total iron content and the redox state of iron in the glass can drastically affect the distribution of Fe⁺², Fe⁺³ and the iron chromaphore in glass and the subsequent absorption spectra, the realization of optimized solar control glasses requires the specification of both the total iron content and the iron redox state.

Optimum solar control glasses require both high levels of iron oxide and high ferrous iron content. The synergistic combinations of high total iron content and high ferrous iron content may be significant.

Table 4 summarizes the calculated synergistic effect of iron redox potential expressed as the molar fraction of the total iron present in the ferrous state (Fe⁺²/Feₜₒₜ) and total batched iron (wt. % Fe₂O₃) on solar and visible transmittances at 3.3 mm glass thickness. As can be seen by inspection of Table 4, neither high iron content nor high ferrous iron content alone achieves the absolute optimal solar control characteristics. The synergistic combination of high total iron content in a highly reduced redox state may improve solar control glasses.

Thus, high total iron content in combination with high redox potential redox potential being Fe⁺²/Feₜₒₜ; preferably>80%, may be preferred. This may result in substantially reduced solar-IR transmittance, which largely drives the substantial improvements in the solar control properties of the glasses under consideration.

Table 5 summarizes the solar-IR transmittances as a function of iron redox state and total iron content.

TABLE 4
Fe⁺² / Feₜₒₜ

| Fe₂O₃ | 22 | 27 | 31 | 41 | 61 | 80 |
|---|---|---|---|---|---|---|
| (wt %) | (%) | (%) | (%) | (%) | (%) | (%) |
| 0.8 | 74 42) | 73 (39) | 72 (37) | 70 (34) | 66 (28) | 62 (25) |
| 0.7 | 78 (42) | 78 (40) | 77 (38) | 75 (35) | 71 (30) | 68 (27) |
| 0.6 | 83 (43) | 82 (41) | 81 (40) | 79 (37) | 76 (33) | 73 (29) |
| 0.5 | 86 (45) | 86 (44) | 85 (42) | 83 (40) | 81 (35) | 78 (32) |
| 0.4 | 89 (48) | 89 (47) | 88 (46) | 87 (43) | 84 (39) | 82 (36) |
| 0.3 | 91 (53) | 91 (52) | 90 (50) | 89 (48) | 87 (44) | 85 (41) |
| 0.2 | 92 (60) | 92 (59) | 91 (58) | 91 (56) | 89 (52) | 88 (49) |
| 0.1 | 92 (71) | 92 (70) | 91 (70) | 91 (68) | 90 (65) | 90 (63) |
| 0.0 | 91 (91) | | | | | |

The effect of iron content and redox potential on visible and solar transmittances. Solar transmittances are given in parenthesis.

TABLE 5
Fe⁺² / Feₜₒₜ

| Fe₂O₃ | 22 | 27 | 31 | 41 | 61 | 80 |
|---|---|---|---|---|---|---|
| (wt %) | (%) | (%) | (%) | (%) | (%) | (%) |
| 0.8 | 23 | 20 | 17 | 13 | 7 | 4 |
| 0.7 | 21 | 19 | 16 | 13 | 8 | 5 |
| 0.6 | 21 | 19 | 17 | 14 | 9 | 6 |
| 0.5 | 22 | 20 | 19 | 15 | 11 | 8 |
| 0.4 | 26 | 24 | 22 | 19 | 14 | 10 |
| 0.3 | 31 | 29 | 28 | 24 | 19 | 15 |
| 0.2 | 41 | 39 | 37 | 35 | 29 | 25 |
| 0.1 | 59 | 56 | 56 | 53 | 49 | 45 |
| 0.0 | 90 | | | | | |

The effect of iron content and redox potential on solar-IR transmittances.

This invention discloses that high iron content in combination with highly reduced redox state imparts a superior ratio of solar visible transmittance to total visible transmittance (Solar-VT/VT). A decrease in the ratio of Solar-VT to visible transmittance implies favorable solar control impact in that a reduction in the total solar energy in the visible portion of the solar spectrum is achieved without a corresponding decrease in the visible transmittance as perceived by the human eye. Table 6 summarizes the effect of iron redox potential and total iron content on Solar-VT/VT ratio. As can be seen by inspection of Table 6, a reduction in the Solar-VT/VT ratio is evident with the combination of high total iron and highly reduced redox state.

TABLE 6
Fe⁺² / Feₜₒₜ

| Fe₂O₃ | 22 | 27 | 31 | 41 | 61 | 80 |
|---|---|---|---|---|---|---|
| (wt %) | (%) | (%) | (%) | (%) | (%) | (%) |
| 0.8 | 0.79 | 0.78 | 0.76 | 0.74 | 0.71 | 0.68 |
| 0.7 | 0.77 | 0.75 | 0.74 | 0.73 | 0.70 | 0.67 |
| 0.6 | 0.76 | 0.75 | 0.74 | 0.72 | 0.70 | 0.68 |
| 0.5 | 0.76 | 0.75 | 0.74 | 0.73 | 0.71 | 0.69 |
| 0.4 | 0.77 | 0.76 | 0.76 | 0.75 | 0.72 | 0.71 |
| 0.3 | 0.79 | 0.79 | 0.78 | 0.77 | 0.76 | 0.74 |
| 0.2 | 0.84 | 0.83 | 0.83 | 0.82 | 0.81 | 0.79 |
| 0.1 | 0.90 | 0.90 | 0.90 | 0.89 | 0.88 | 0.87 |
| 0.0 | 1.00 | | | | | |

The effect of iron content and redox potential on the Solar-VT/VT ratio.

Nickel Oxide:

Nickel Oxide (NiO) occurs almost exclusively in the divalent state (Ni⁺²) in soda-lime-silicate glasses fired under ambient to moderately reducing conditions of oxygen fugacity. The Ni⁺² cation may exist simultaneously in both octahedral and tetrahedral coordination with Ni⁺² (IV) manifesting absorption bands at 560, 630 and 1200 nm and Ni⁺² (VI) manifesting absorption bands in the visible (450 nm) and in the infrared (930, 1800 nm). Two indistinct absorption bands occur in the IR at 1.1 and 2.2 μm. Nickel manifests roughly 49 times greater absorbing power in the visible relative to iron, which makes nickel oxide an ideal dopant for the decreased visible transmittance essential to privacy control automotive glasses and commercial building glasses. Furthermore, neutral grey to yellow-brown product colorations can be achieved with NiO additions making the dopant essential for color neutral privacy glasses. Relative to solar control applications, Ni⁺² manifests strong absorption bands on either side of the transmission maxima necessary to achieve optimum solar control properties. For this reason, NiO additions to solar control glasses can impart a multitude of product functionality essential for the optimization of solar control glasses.

The Ni⁺² cation, under the appropriate ranges in oxygen fugacity, can form undesirable NiS inclusions, which impart undesirable product colorations, and also can cause the glass to be brittle, i.e, it may have reduced impact strength. This has limited NiO as a colorant in residential glasses. The present system uses another dopant to inhibit the formation of nickel sulfide inclusions. One such dopant is ZnO. By adding both NiO and ZnO, the advantages of NiO (visible transmission) may be obtained without NiO's undesirable features, as described above. This may enhance the performance of solar control glasses. The current invention discloses that NiO additions ranging between 0.0001 wt % and 0.1 wt %, in combination with other dopants, allow for reduced visible transmittance, increased IR absorption and superior solar control properties for privacy applications.

Cobalt Oxide:

Cobalt oxide (CoO) occurs primarily in the divalent (Co⁺²) state in silicate glasses fired under typical ranges of oxygen fugacity Co⁺² occurs simultaneously in both octahedral and tetrahedral coordinations which imparts pink and blue coloration respectively. C⁺² in its octahedral coordination is stable only at low temperatures in highly acidic glasses. Co⁺² in tetrahedral coordination exhibits absorption bands from 600-650 nm and 500-550 nm range in the visible. In the IR, Co⁺² (IV) manifests two absorption bands at 1.25 and 1.75 μm. Cobalt oxide manifests the most intense visible coloration of all the ionically coloring elements with blue coloration apparent at CoO concentrations of 1.10-2.10*10⁻⁶%, which is 213 times more intense than iron oxide. Despite the attractiveness of CoO in the reduction of visible transmittance for privacy applications as well as its IR absorption for solar control properties, CoO absorbs strongly in the area of the ideal transmission peak, which limits its application in solar control glasses. Despite this shortcoming, CoO at low levels is ideal for imparting blue coloration to solar control glasses in which other dopants provide the optimal solar control characteristics. The current invention discloses that small additions of CoO ranging from 0.0001 wt % to 0.03 wt %, in combination with other dopants allows for the tailoring of product coloration which is essential for the realization of commercially viable solar control glasses for privacy applications in vans and trucks and commercial buildings.

Vanadium Oxide:

Vanadium oxide occurs as V⁺⁵, V⁺⁴, V⁺³ and V⁺² in glass with V⁺⁵ representing the most stable forms in silicate glasses. Bivalent vanadium has a high tendency to oxidize at both high temperatures and under reducing conditions and is therefore not normally stable in silicate glasses. Tetravalent vanadium is also unstable and has only been observed in borate and phosphate glasses after electrolytic reduction. V⁺⁵ occurs in both octahedral and tetrahedral coordination with a broad absorption band in the UV which trails into the visible at 350 nm imparting a yellow coloration to glass. V⁺³ imparts a green coloration to glass with absorption maxima at 425 and 625 nm and transmission maxima at 525 nm. In the IR, V⁺⁵ absorbs at 1.1 μm. The visible absorption imparted by V₂O₅ is quite weak with an intensity roughly one-half that of Fe₂O₃. The combination of intense UV absorption, suitable visible characteristics relative to the ideal transmission spectra, and IR absorption makes V₂O₅ and ideal dopant for solar control glasses in amounts higher than 0.001 wt %.

Titanium Dioxide:

Titanium oxide occurs in both the tetravalent Ti⁺⁴ and the trivalent Ti⁺³ oxidation state in glass; however, Ti⁺³ exists only under reducing conditions of oxygen fugacity. Ti⁺³ imparts violet coloration in glass. The coloration imparted by Ti⁺³ has no commercially relevant applications as Mn⁺³ can be utilized far more effectively for the production of violet coloration. Ti⁺⁴ produces no coloration in glass up to 5 wt %, however it is known that Ti⁺⁴ additions to glass can strongly effect the coloration of tonically coloring transition metals. This effect is not due to alterations in the oxidation state of the transition metals, but rather in shift in the absorption curves to longer wavelengths due to the weakening of the metal-oxygen bonds from the close proximity of the high field strength Ti⁺⁴ cation. This effect applies particularly for iron oxide whereby TiO₂ additions impart deeper color saturation to FeO. TiO₂ has been shown to shift the coloration of FeO from blue to brown, MnO from colorless to yellow, NiO from grey to yellow-brown and for CuO from blue to green. TiO₂ additions have not been shown to impact the coloration of Fe⁺³, Mn⁺³, Cr⁺³, U⁺⁴ and V⁺⁵.

TiO₂ has been shown to manifest absorption in the UV. By contrast, TiO₂ additions act to decrease the absorption in the IR particularly in the presence of fluorine. TiO₂ additions have been shown to shift Fe⁺³ from octahedral to tetrahedral coordination in glass resulting in enhanced UV absorption of the Fe⁺³(IV) cation. For these reasons, the functionality of TiO₂ in solar control glasses is primarily related to increased UV absorption and modification of product coloration via interactions with NiO and FeO. Table 7 summarize the calculated a*,b* color coordinates for glasses containing 0.10 wt. % NiO, 0.8 wt. % Fe₂O₃, and 0.05 wt. % CoO both with and without TiO₂ additions.

TABLE 7

| TiO₂ | 0.05% CoO | 0.10% NiO | 0.80% Fe₂O₃ | 0.80% Fe₂O₃ |
|---|---|---|---|---|
| (%) | 2.00% SnO | 2.00% SnO | 2.00% SnO | 0.0% SnO |
| 0.0 | a* = 12.72 | a* = −7.30 | a* = −12.06 | a* = −3.62 |
| | b* = −60.08 | b* = 27.07 | b* = 12.76 | b* = 16.42 |
| 0.5 | a* = −12.78 | a* = 7.15 | a* = −11.76 | a* = −3.98 |
| | b* = −60.04 | b* = 28.12 | b* = 10.03 | b* = 15.92 |
| 1.0 | a* = −12.85 | a* = 7.00 | a* = −11.43 | a* = −4.34 |
| | b* = −59.99 | b* = 29.17 | b* = 7.49 | b* = 15.43 |
| 1.5 | a* = −12.91 | a* = 6.86 | a* = −11.09 | a* = −4.69 |
| | b* = −59.94 | b* = 30.22 | b* = 5.15 | b* = 14.95 |

The effect of TiO₂ on product coloration of CoO, NiO and Fe₂O₃ doped glasses.

As can be seen by inspection of Table 7, TiO₂ additions to the CoO glass has very little impact although a slight color shift from less blue to more green is evident. The effect of TiO₂ on NiO is to produce a more color neutral a* coordinate (red-green) while increasing the yellow coloration of the glass. The iron containing glasses are all yellow-green in coloration with the glass containing 2.0% SnO being considerably less yellow than the equivalent glass containing no SnO. The effect of TiO₂ on iron containing glasses appears to be most pronounced under highly reducing conditions in which case the glass becomes less yellow and less green. Under oxidizing conditions the iron containing glasses appear to become less yellow and slightly greener in coloration.

Titanium dioxide may be used in amounts greater than 0.1 wt %.

Phosphorous Pentoxide:

Phosphorous pentoxide occurs only in the pentavalent state (P⁺⁵) in silicate glasses with tetrahedral coordination. P₂O₅ is poorly soluble in silicate glasses and can lead to opacity above 2 wt. %. P₂O₅ manifests no commercially relevant absorption band in the UV, visible or in the IR. The functionality is hence based on its interaction with other constituents in the glass. P₂O₅ enhances the absorption of ferrous iron in the near IR. This imparts useful functionality in solar control glasses. P₂O₅ may stabilize the octahedral coordination state of ferric iron (Fe⁺³), and hence reduce the visible absorption relative to the tetrahedral complex. This effect is referred to as chemical decolorization. It is believed to occur mainly in phosphate-based glasses. P₂O₅ has been reported to have a scavenging effect towards Fe⁺³ when incorporated as a minor constituent in silicate glasses. For this reason, P₂O₅ additions are likely to have decolorizing effects on Fe⁺³ and other transition metal dopants when P₂O₅ is added to silicate glasses. The combination of enhanced IR absorption and reduced visible coloration by P₂O₅ may have novel applications for solar control glasses. Table 8 summarizes the calculated effect of P₂O₅ on the solar-IR transmittance for a glass containing 0.8 wt. % Fe₂O₃, 2.0 wt % SnO at 3.3 mm thickness.

TABLE 8
The effect of P₂O₅ additions on the Solar-IR transmittance
for a glass containing 0.8 wt. % Fe₂O₃ and 2.0% SnO.

| P₂O₅ | Solar-IR |
|---|---|
| (%) | (%) |
| 0.0 | 7.21 |
| 0.5 | 6.10 |
| 1.0 | 5.17 |
| 1.5 | 4.40 |

As can be seen by inspection of Table 8, P₂O₅ additions to glasses containing Fe₂O₃ under strongly reducing conditions (3.0%±1% SnO) may have substantially reduced solar-IR transmittances. Another important aspect of this invention is that glasses containing P₂O₅ in the range of 0.1 wt % to 2.0 wt % in combination with high levels of Fe₂O₃ and high redox potential provide for substantial reductions in both solar-IR and total solar transmittances.

ZnO:

ZnO does not manifest absorption bands in the UV, visible or the near-IR and hence imparts functionality in solar control glasses only by virtue of its interaction with other dopants. ZnO has been shown to inhibit the formation of strongly coloring transition metal sulfides in glasses fired under reducing condition by the preferential formation of colorless ZnS complexes. ZnO is unique in this respect among the transition metal oxides in that it alone forms a colorless complex with the sulfide anion. The current invention teaches that ZnO additions to solar control glasses containing CoO, Fe₂O₃ and NiO inhibit the formation of strongly colored transition metal complexes, which would otherwise have deleterious effects on both the mechanical and optical properties of the glass. This finding can be supported by the large negative free energy of formation of the ZnS complex (−48.11 Kcal/mol) relative to the free energies of formation of FeS (−23.87 Kcal/mol), NiS (−19.0 Kcal/mol) and CoS (−20.20 Kcal/mol) and by the model prediction of Table 9.

TABLE 9

| ZnO | 0.10% NiO | 0.10% NiO | 0.8% Fe₂O₃ | 0.8% Fe₂O₃ | 0.05% CoO |
|---|---|---|---|---|---|
| (%) | 2.0% SnO | 0.0% SnO | 2.0% SnO | 0.0% SnO | 2.0% SnO |
| 0.0 | 63 | 63 | 66 | 74 | 22 |
| 0.5 | 64 | 64 | 67 | 75 | 22 |
| 1.0 | 65 | 65 | 69 | 77 | 22 |
| 1.5 | 66 | 66 | 70 | 78 | 22 |
| 2.0 | 67 | 67 | 71 | 80 | 22 |

The effect of ZnO additions on the visible transmittances of NiO, Fe₂O₃, and CoO containing glasses at 3.3 mm thickness.

As can be seen by inspection of Table 9, ZnO appears to act as an optical clarifier for both NiO and Fe₂O₃ with an associated increase of approximately 4 and 5 percent respectively upon the addition of 2.0 wt. % ZnO. ZnO appears to have little impact on CoO containing glasses. ZnO may be used in amounts greater than 0.1 wt %.

Fluorine:

Halogens in glasses rarely exceed 1% as the halogens show limited solubility in silicate glasses. The addition of elements which are capable of increasing their coordination number (B⁺³ or Al⁺³) increases the solubility of fluorine. In aluminate glasses, fluorine can substitute up to 7% of the oxygen. Halogens have only marginal impact on the optical properties of glasses. Approximately 30-50% of the original Fe₂O₃ coloration can be eliminated by fluoride additions to iron containing soda-lime-silicate glasses whereas chlorides and iodides are effective in eliminating only about 10-25% of the iron coloration. Originally, it was assumed that this decolorization was due to enhanced volatilization losses of volatile iron halide complexes, though this explanation has been discounted. It is now known that this effect is due to the formation of colorless [FeF₆]⁻³ complexes, though it is,unlikely that all six of the oxide anions coordinated to Fe⁺³ is replaced by F−. The presence of fluorine has not be shown to affect the coloration of Fe⁺² in either aqueous or glass systems. The decolorization of Fe⁺³ imparted by fluorine additions to iron containing glasses suggest the possibility of novel solar-control characteristics.

Tin Oxide:

Tin oxide is capable of existing as Sn⁺² and Sn⁺⁴ in glasses with octahedral coordination likely for both cations though tetrahedral coordination can not be ruled out for Sn⁺⁴. SnO transforms to SnO₂ when heated in air above 220° C. which indicates that SnO is a powerful reducing agent in glass. SnO position on the Ellingham Diagram indicates that SnO will reduce both Fe₂O₃ and Co₂O₃. SnO also exhibits a high atomic polarizability indicating that SnO additions will increase the index of refraction of soda-lime-silicate glasses. SnO main functionality, with respect to optical properties of glass involves alteration of the redox state of transition metal oxides. It should also be noted that SnO additions are vital to the formation of colloidal ruby glasses involving CuO, AuO and AgO due to the metalophilic properties of SnO. In terms of solar-control glasses, SnO has been largely exploited to control redox state of transition metal colorants.

Zinc Sulphide:

Zinc Sulphide acts both as a reducing agent and as a source of the S⁻² anion which is necessary for the formation of metal sulphide chromophores. Heavy metal sulphides are poorly soluble in basic glasses and sulphides tend to precipitate upon cooling. ZnS, CdS and MnS manifest the highest solubility of the heavy metal sulphides whereas CaS, FeS, MgS, PbS are poorly soluble and Ag₂S, CuS and NiS are virtually insoluble. At high temperatures, ZnS stabilizes the solubility of metal sulphides which provides a reservoir for the S⁻² anion necessary for the formation of the transition metal chromophore. The functionality of ZnS in solar-control glasses is therefore limited to the role of a reducing agent and as a reservoir for the S⁻² anion and subsequent chromohore formation.

Model Predictions:

Tables 10-15 establish the calculated solar control, privacy and color properties of glasses containing 0.8 wt % Fe₂O₃, 3% SnO, 2% P₂O₅, 2% ZnO, 0.05% V₂O₅ at various levels of NiO and CoO ranging between 0.025 to 0.09% for NiO and 0.00175 to 0.026625% for CoO.

TABLE 10
Table 10 shows visible transmittance of glasses containing 0.8% Fe₂O₃, 3.0% SnO,
2.0% P₂O₅, 2.0% ZnO, 0.05% V₂O₅ as a function of NiO and CoO content.
The highlighted bands represent right to left, visible transmittances between 15-20%,
20-25% and 25-30% respectively.

| | CoO (wt. %) | | | | | | | | | | |
|---|---|---|---|---|---|---|---|---|---|---|---|
| NiO (wt. %) | 0.00175 | 0.00413 | 0.00663 | 0.00913 | 0.011625 | 0.01413 | 0.01663 | 0.01913 | 0.02163 | 0.02413 | 0.02663 |
| 0.025 | 41.67 | 38.98 | 36.36 | 33.95 | 31.72 | 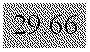 | 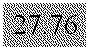 | 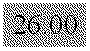 | 24.37 | 22.86 | 21.46 |
| 0.03 | 39.67 | 37.11 | 34.63 | 32.33 | 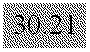 | 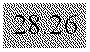 | 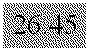 | 24.78 | 23.23 | 21.79 | 20.46 |
| 0.035 | 37.77 | 35.34 | 32.97 | 30.79 | 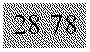 | 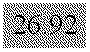 | 25.20 | 23.61 | 22.14 | 20.78 | 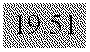 |
| 0.04 | 35.95 | 33.65 | 31.40 | 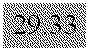 | 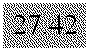 | 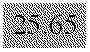 | 24.02 | 22.50 | 21.10 | 19.81 | 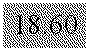 |
| 0.045 | 34.23 | 32.04 | 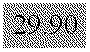 | 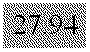 | 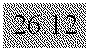 | 24.44 | 22.88 | 21.45 | 20.12 | 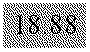 | 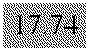 |
| 0.05 | 32.58 | 30.50 | 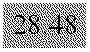 | 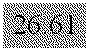 | 24.88 | 23.28 | 21.81 | 20.44 | 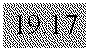 | 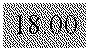 | 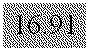 |
| 0.055 | 31.02 | 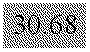 | 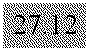 | 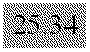 | 23.70 | 22.19 | 20.78 | 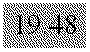 | 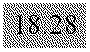 | 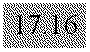 | 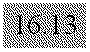 |
| 0.06 | 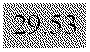 | 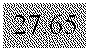 | 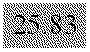 | 24.14 | 22.58 | 21.14 | 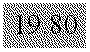 | 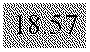 | 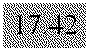 | 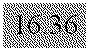 | 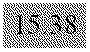 |
| 0.065 | 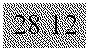 | 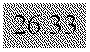 | 24.60 | 22.99 | 21.51 | 20.14 | 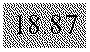 | 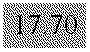 | 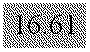 | 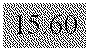 | 14.66 |
| 0.07 | 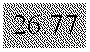 | 25.07 | 23.43 | 21.90 | 20.49 | 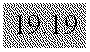 | 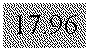 | 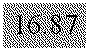 | 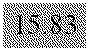 | 14.87 | 13.98 |
| 0.075 | 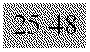 | 23.88 | 22.31 | 20.86 | 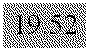 | 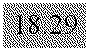 | 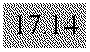 | 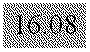 | 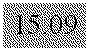 | 14.18 | 13.33 |
| 0.08 | 24.26 | 22.73 | 21.25 | 19.87 | 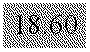 | 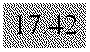 | 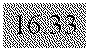 | 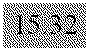 | 14.39 | 13.52 | 12.71 |
| 0.085 | 23.10 | 21.65 | 20.24 | 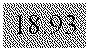 | 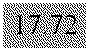 | 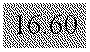 | 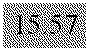 | 14.61 | 13.72 | 12.89 | 12.12 |
| 0.09 | 21.99 | 20.62 | 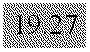 | 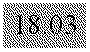 | 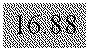 | 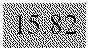 | 14.84 | 13.92 | 13.08 | 12.29 | 11.56 |

TABLE 11
Table 11 shows solar transmittance of glasses containing 0.8% Fe₂O₃, 3.0% SnO,
2.0% P₂O₅, 2.0% ZnO, 0.05% V₂O₅ as a function of NiO and CoO content.
The highlighted bands represent, right to left, visible transmittances between 15-20%,
20-25% and 25-30% respectively.

| | CoO (wt. %) | | | | | | | | | | |
|---|---|---|---|---|---|---|---|---|---|---|---|
| NiO (wt. %) | 0.00175 | 0.00413 | 0.00663 | 0.00913 | 0.011625 | 0.01413 | 0.01663 | 0.01913 | 0.02163 | 0.02413 | 0.02663 |
| 0.025 | 18.16 | 17.61 | 17.08 | 16.61 | 16.19 | 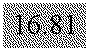 | 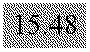 | 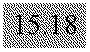 | 14.92 | 14.69 | 14.50 |
| 0.03 | 17.60 | 17.08 | 16.59 | 16.15 | 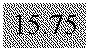 | 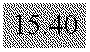 | 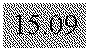 | 14.81 | 14.57 | 14.36 | 14.18 |
| 0.035 | 17.07 | 16.59 | 16.12 | 15.71 | 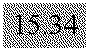 | 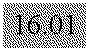 | 14.72 | 14.46 | 14.24 | 14.04 | 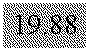 |
| 0.04 | 16.58 | 16.12 | 15.68 | 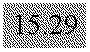 | 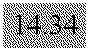 | 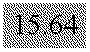 | 14.37 | 14.13 | 13.92 | 13.75 | 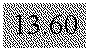 |
| 0.045 | 16.10 | 15.67 | 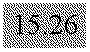 | 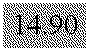 | 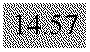 | 14.29 | 14.03 | 13.82 | 13.63 | 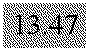 | 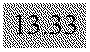 |
| 0.05 | 15.65 | 15.25 | 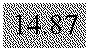 | 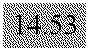 | 14.22 | 13.96 | 13.72 | 13.52 | 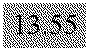 | 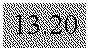 | 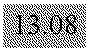 |
| 0.055 | 15.23 | 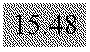 | 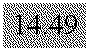 | 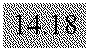 | 13.89 | 13.65 | 13.43 | 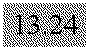 | 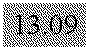 | 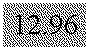 | 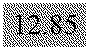 |
| 0.06 | 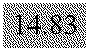 | 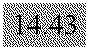 | 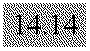 | 13.84 | 13.58 | 13.35 | 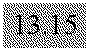 | 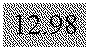 | 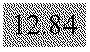 | 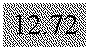 | 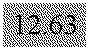 |
| 0.065 | 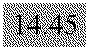 | 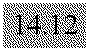 | 13.81 | 13.53 | 13.29 | 13.08 | 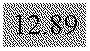 | 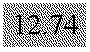 | 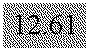 | 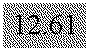 | 12.43 |
| 0.07 | 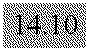 | 13.78 | 13.49 | 13.24 | 13.01 | 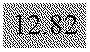 | 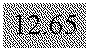 | 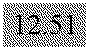 | 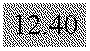 | 12.30 | 12.23 |
| 0.075 | 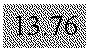 | 13.47 | 13.20 | 12.96 | 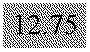 | 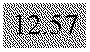 | 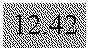 | 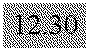 | 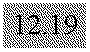 | 12.11 | 12.06 |
| 0.08 | 13.44 | 13.17 | 12.92 | 12.70 | 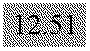 | 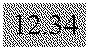 | 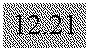 | 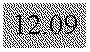 | 12.01 | 11.94 | 11.89 |
| 0.085 | 13.14 | 12.89 | 12.65 | 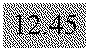 | 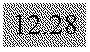 | 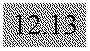 | 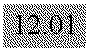 | 11.91 | 11.83 | 11.77 | 11.74 |
| 0.09 | 12.85 | 12.62 | 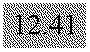 | 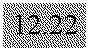 | 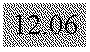 | 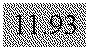 | 11.82 | 11.73 | 11.67 | 11.62 | 11.60 |

TABLE 12
Table 12 shows Solar-IR transmittance of glasses containing 0.8% Fe₂O₃, 3.0% SnO,
2.0% P₂O₅, 2.0% ZnO, 0.05% V₂O₅ as a function of NiO and CoO content.
The highlighted bands represent, right to left, visible transmittances between 15-20%,
20-25% and 25-30% respectively.

| | CoO (wt. %) | | | | | | | | | | |
|---|---|---|---|---|---|---|---|---|---|---|---|
| NiO (wt. %) | 0.00175 | 0.00413 | 0.00663 | 0.00913 | 0.011625 | 0.01413 | 0.01663 | 0.01913 | 0.02163 | 0.02413 | 0.02663 |
| 0.025 | 4.86 | 4.95 | 5.06 | 5.16 | 5.28 | 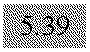 | 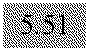 | 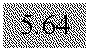 | 5.77 | 5.91 | 6.05 |
| 0.03 | 4.92 | 5.01 | 5.12 | 5.23 | 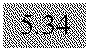 | 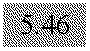 | 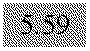 | 5.71 | 5.85 | 5.99 | 6.13 |
| 0.035 | 4.98 | 5.08 | 5.18 | 5.30 | 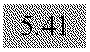 | 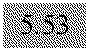 | 5.66 | 5.79 | 5.93 | 6.07 | 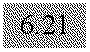 |
| 0.04 | 5.04 | 5.14 | 5.25 | 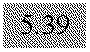 | 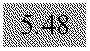 | 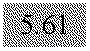 | 5.73 | 5.87 | 6.01 | 6.15 | 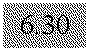 |
| 0.045 | 5.10 | 5.20 | 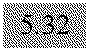 | 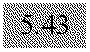 | 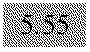 | 5.68 | 5.81 | 5.95 | 6.09 | 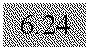 | 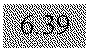 |
| 0.05 | 5.16 | 5.27 | 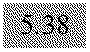 | 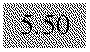 | 5.63 | 5.76 | 5.89 | 6.03 | 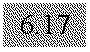 | 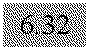 | 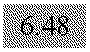 |
| 0.055 | 5.23 | 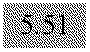 | 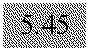 | 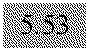 | 5.70 | 5.83 | 5.97 | 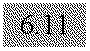 | 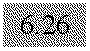 | 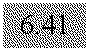 | 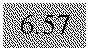 |
| 0.06 | 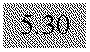 | 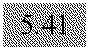 | 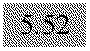 | 5.65 | 5.78 | 5.91 | 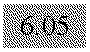 | 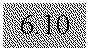 | 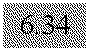 | 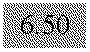 | 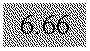 |
| 0.065 | 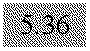 | 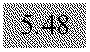 | 5.60 | 5.72 | 5.85 | 5.99 | 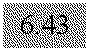 | 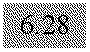 | 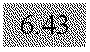 | 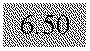 | 6.76 |
| 0.07 | 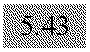 | 5.55 | 5.67 | 5.80 | 5.93 | 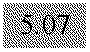 | 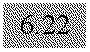 | 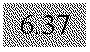 | 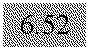 | 6.69 | 6.86 |
| 0.075 | 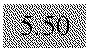 | 5.62 | 5.75 | 5.88 | 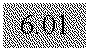 | 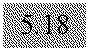 | 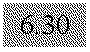 | 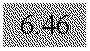 | 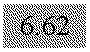 | 6.78 | 6.96 |
| 0.08 | 5.57 | 5.69 | 5.82 | 5.96 | 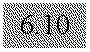 | 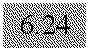 | 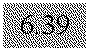 | 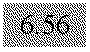 | 6.71 | 6.88 | 7.06 |
| 0.085 | 5.65 | 5.77 | 5.90 | 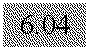 | 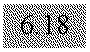 | 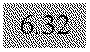 | 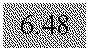 | 6.64 | 6.81 | 6.98 | 7.16 |
| 0.09 | 5.72 | 5.85 | 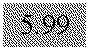 | 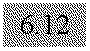 | 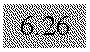 | 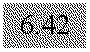 | 6.57 | 6.74 | 6.91 | 7.08 | 7.27 |

TABLE 13
Table 13 shows Solar-VT transmittance of glasses containing 0.8% Fe₂O₃, 3.0% SnO,
2.0% P₂O₅, 2.0% ZnO, 0.05% V₂O₅ as a function of NiO and CoO content.
The highlighted bands represent, right to left, visible transmittances between 15-20%,
20-25% and 25-30% respectively.

| | CoO (wt. %) | | | | | | | | | | |
|---|---|---|---|---|---|---|---|---|---|---|---|
| NiO (wt. %) | 0.00175 | 0.00413 | 0.00663 | 0.00913 | 0.011625 | 0.01413 | 0.01663 | 0.01913 | 0.02163 | 0.02413 | 0.02663 |
| 0.025 | 28.39 | 27.21 | 26.07 | 25.04 | 24.10 | 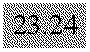 | 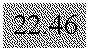 | 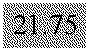 | 21.11 | 20.53 | 20.01 |
| 0.03 | 27.23 | 26.11 | 25.04 | 24.06 | 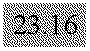 | 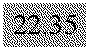 | 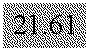 | 20.94 | 20.34 | 19.79 | 19.30 |
| 0.035 | 26.13 | 25.07 | 24.05 | 23.12 | 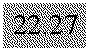 | 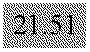 | 20.81 | 20.18 | 19.60 | 19.09 | 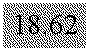 |
| 0.04 | 25.08 | 24.08 | 23.11 | 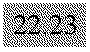 | 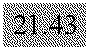 | 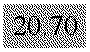 | 20.04 | 19.45 | 18.91 | 18.42 | 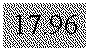 |
| 0.045 | 24.09 | 23.13 | 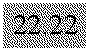 | 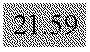 | 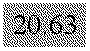 | 19.94 | 19.32 | 18.75 | 18.24 | 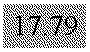 | 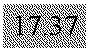 |
| 0.05 | 23.14 | 22.24 | 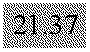 | 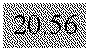 | 19.87 | 19.22 | 18.63 | 18.09 | 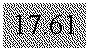 | 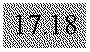 | 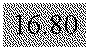 |
| 0.055 | 22.14 | 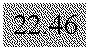 | 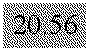 | 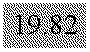 | 19.14 | 18.53 | 17.97 | 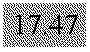 | 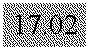 | 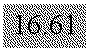 | 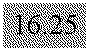 |
| 0.06 | 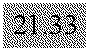 | 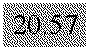 | 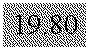 | 19.09 | 18.45 | 17.87 | 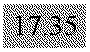 | 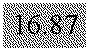 | 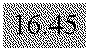 | 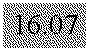 | 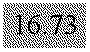 |
| 0.065 | 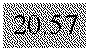 | 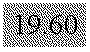 | 19.07 | 18.40 | 17.80 | 17.25 | 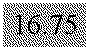 | 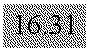 | 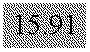 | 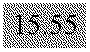 | 15.23 |
| 0.07 | 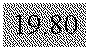 | 19.07 | 18.38 | 17.75 | 17.17 | 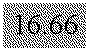 | 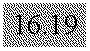 | 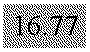 | 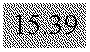 | 15.06 | 14.76 |
| 0.075 | 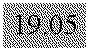 | 18.37 | 17.72 | 17.12 | 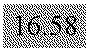 | 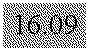 | 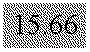 | 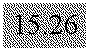 | 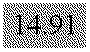 | 14.59 | 14.31 |
| 0.08 | 18.36 | 17.71 | 17.09 | 16.53 | 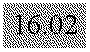 | 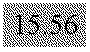 | 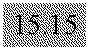 | 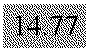 | 14.44 | 14.15 | 13.89 |
| 0.085 | 17.70 | 17.08 | 16.50 | 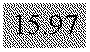 | 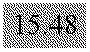 | 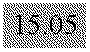 | 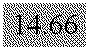 | 14.31 | 14.00 | 13.73 | 13.48 |
| 0.09 | 17.06 | 16.48 | 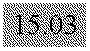 | 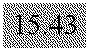 | 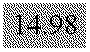 | 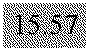 | 14.20 | 13.88 | 13.59 | 13.33 | 13.10 |

TABLE 14
Table 14 shows Solar-VT/VT of glasses containing 0.8% Fe₂O₃, 3.0% SnO,
2.0% P₂O₅, 2.0% ZnO, 0.05% V₂O₅ as a function of NiO and CoO content.
The highlighted bands represent, right to left, visible transmittances between 15-20%,
20-25% and 25-30% respectively.

| | CoO (wt. %) | | | | | | | | | | |
|---|---|---|---|---|---|---|---|---|---|---|---|
| NiO (wt. %) | 0.00175 | 0.00413 | 0.00663 | 0.00913 | 0.011625 | 0.01413 | 0.01663 | 0.01913 | 0.02163 | 0.02413 | 0.02663 |
| 0.025 | 0.68 | 0.70 | 0.72 | 0.74 | 0.76 | 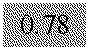 | 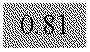 | 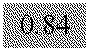 | 0.87 | 0.90 | 0.93 |
| 0.03 | 0.69 | 0.70 | 0.72 | 0.74 | 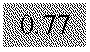 | 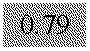 | 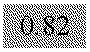 | 0.85 | 0.88 | 0.91 | 0.94 |
| 0.035 | 0.69 | 0.71 | 0.73 | 0.75 | 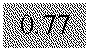 | 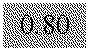 | 0.83 | 0.85 | 0.89 | 0.92 | 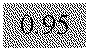 |
| 0.04 | 0.70 | 0.72 | 0.74 | 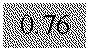 | 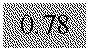 | 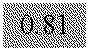 | 0.83 | 0.86 | 0.90 | 0.93 | 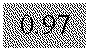 |
| 0.045 | 0.70 | 0.72 | 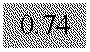 | 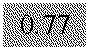 | 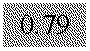 | 0.82 | 0.84 | 0.87 | 0.91 | 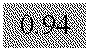 | 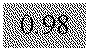 |
| 0.05 | 0.71 | 0.73 | 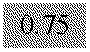 | 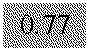 | 0.80 | 0.83 | 0.85 | 0.89 | 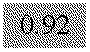 | 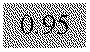 | 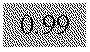 |
| 0.055 | 0.72 | 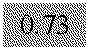 | 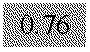 | 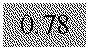 | 0.81 | 0.84 | 0.86 | 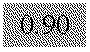 | 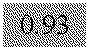 | 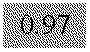 | 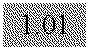 |
| 0.06 | 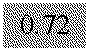 | 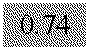 | 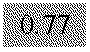 | 0.79 | 0.82 | 0.85 | 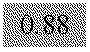 | 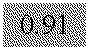 | 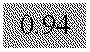 | 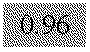 | 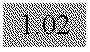 |
| 0.065 | 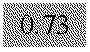 | 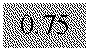 | 0.78 | 0.80 | 0.83 | 0.86 | 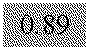 | 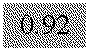 | 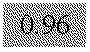 | 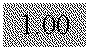 | 1.04 |
| 0.07 | 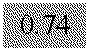 | 0.76 | 0.78 | 0.81 | 0.84 | 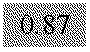 | 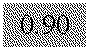 | 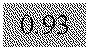 | 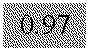 | 1.01 | 1.06 |
| 0.075 | 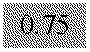 | 0.77 | 0.79 | 0.82 | 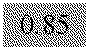 | 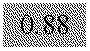 | 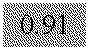 | 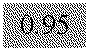 | 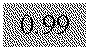 | 1.03 | 1.07 |
| 0.08 | 0.76 | 0.78 | 0.80 | 0.83 | 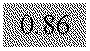 | 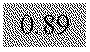 | 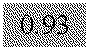 | 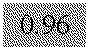 | 1.00 | 1.05 | 1.09 |
| 0.085 | 0.77 | 0.79 | 0.82 | 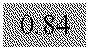 | 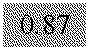 | 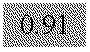 | 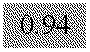 | 0.98 | 1.02 | 1.06 | 1.11 |
| 0.09 | 0.78 | 0.80 | 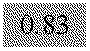 | 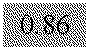 | 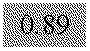 | 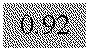 | 0.96 | 1.00 | 1.04 | 1.08 | 1.13 |

TABLE 15
Table 15 shows the b* color coordinate of glasses containing 0.8% Fe₂O₃, 3.0% SnO,
2.0% P₂O₅, 2.0% ZnO, 0.05% V₂O₅ as a function of NiO and CoO content.
The leftmost highlighted band yellow-green represent the compositions in which the glass
has yellow-green coloration. The rightmost highlighted band represent the
compositions in which the glass has blue-green coloration.

| | CoO (wt. %) | | | | | | | | | | |
|---|---|---|---|---|---|---|---|---|---|---|---|
| NiO (wt. %) | 0.00175 | 0.00413 | 0.00663 | 0.00913 | 0.011625 | 0.01413 | 0.01663 | 0.01913 | 0.02163 | 0.02413 | 0.02663 |
| 0.025 | 17.83 | 14.52 | 11.14 | 7.84 | 4.63 | 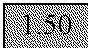 | 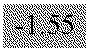 | 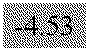 | 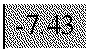 | 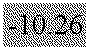 | 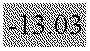 |
| 0.03 | 17.76 | 14.51 | 11.19 | 7.95 | 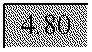 | 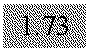 | 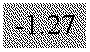 | 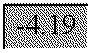 | 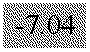 | 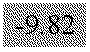 | 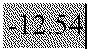 |
| 0.035 | 17.68 | 14.50 | 11.23 | 8.06 | 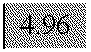 | 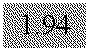 | 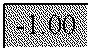 | 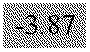 | 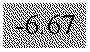 | 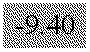 | 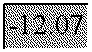 |
| 0.04 | 17.60 | 14.48 | 11.27 | 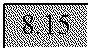 | 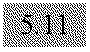 | 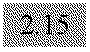 | 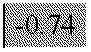 | 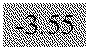 | 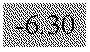 | 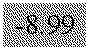 | 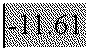 |
| 0.045 | 17.52 | 14.45 | 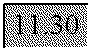 | 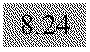 | 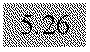 | 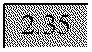 | 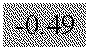 | 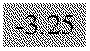 | 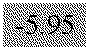 | 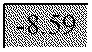 | 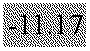 |
| 0.05 | 17.43 | 14.42 | 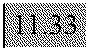 | 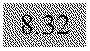 | 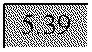 | 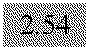 | 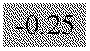 | 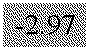 | 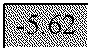 | 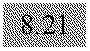 | 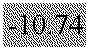 |
| 0.055 | 17.33 | 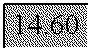 | 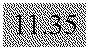 | 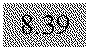 | 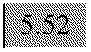 | 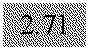 | 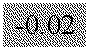 | 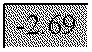 | 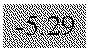 | 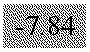 | 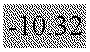 |
| 0.06 | 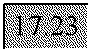 | 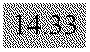 | 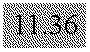 | 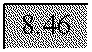 | 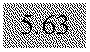 | 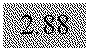 | 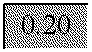 | 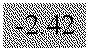 | 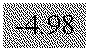 | 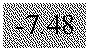 | 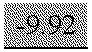 |
| 0.065 | 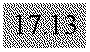 | 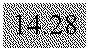 | 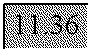 | 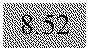 | 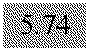 | 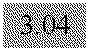 | 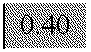 | 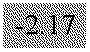 | 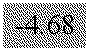 | 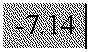 | −9.54 |
| 0.07 | 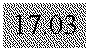 | 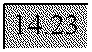 | 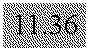 | 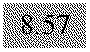 | 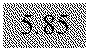 | 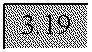 | 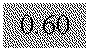 | 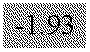 | 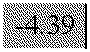 | −6.81 | −9.16 |
| 0.075 | 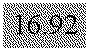 | 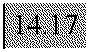 | 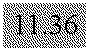 | 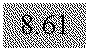 | 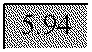 | 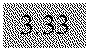 | 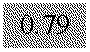 | 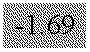 | 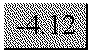 | −6.49 | −8.80 |
| 0.08 | 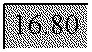 | 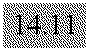 | 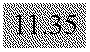 | 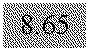 | 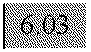 | 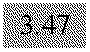 | 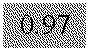 | 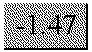 | −3.85 | −6.18 | −8.45 |
| 0.085 | 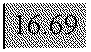 | 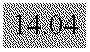 | 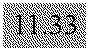 | 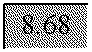 | 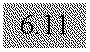 | 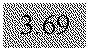 | 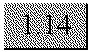 | −1.26 | −3.60 | −5.88 | −8.11 |
| 0.09 | 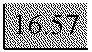 | 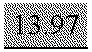 | 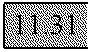 | 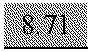 | 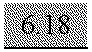 | 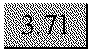 | 1.30 | −1.05 | −3.35 | −5.59 | −7.79 |

Table 12 further suggests that the privacy glasses have substantially reduced solar-IR transmittances (5.3-6.6%) relative to the best solar control privacy glasses currently produced which have solar-IR transmittances of approximately 18% at 24% visible transmittance.

As can be seen by inspection of Table 15, CoO addition in combination with NiO can provide for solar control privacy glasses with varied coloration ranging from yellow-green to blue-green. This invention teaches that varied product coloration can be achieved at many specified degrees of privacy with superior solar control properties.

### EXAMPLE 1

An improved glass for truck and van glass can be made by maximizing the redox potential (FeO/Fe₂O₃), e.g. to greater than 80%, maximizing total iron content while maintaining a visible transmission between 15-27%. One of the best commercially available glasses used in vans and trucks is PPG's GL-20 glass with a visible transmission of about 24% and corresponding solar transmission of about 23% for 3.3 mm glass. By maximizing the redox potential in excess of 80% (with SnO contents of about 3%) and total iron content of about 0.8% e.g. between 0.6% and 1%, three glasses were developed with reduced solar transmission.

Example 1, the first glass with a visible transmission of 15.3% and a solar transmission of 6.4% had a total iron content of 0.813% and a redox potential of 84.9%. Notably, PPG's GL-20 glass has a reported solar IR transmission of 18% at 3.3 mm thickness compared to 3% for glass 1.

### EXAMPLE 2

The second glass has a visible transmission of 27.0% at 4.0 mm, a solar transmission of 8.4% and a corresponding total iron content of 0.810% and redox potential of 84.2%.

### EXAMPLE 3

The third glass had a visible transmission of 23.9% and solar transmission of 11.3% with a total iron content of 0.85% and redox potential of 94.1%. This glass included the additions of 0.016% CoO and 0.06% NiO to alter the color characteristics of the glass and 2.12% P₂O₅ to reduce the solar IR transmission to 3.1%.

Glasses were also developed for commercial buildings with remarkable reductions in solar IR transmission.

### EXAMPLE 4

The first building glass had a visible transmission of 41.8% and a solar transmission of 16.5%. This glass had a total iron content of 0.707% with a redox potential of 82.1%. Another glass was developed for commercial buildings which possessed a visible transmission of 45.57% at a solar transmission of 18.08% containing 0.86% Fe₂O₃ and 0.70% FeO.

Another glass had a visible transmission of 31.2% and a solar transmission of 12.2% and a corresponding total iron content of 0.86% and redox potential of 89.17%. This glass with a 2.1% P₂O₅ addition, had an amazingly low solar IR transmission of 2.73%. This glass had 0.002% CoO and 0.09% NiO to alter the color characteristics of the glass from yellow green to blue green.

Table 16 below provides the detailed composition and extraordinary solar properties of some of these glasses.

| | Glass 1 | Glass 2 | Glass 3 | Glass 4 | Glass 5 | Glass 6 |
|---|---|---|---|---|---|---|
| Fe₂O₃ | 0.813 | 0.810 | 0.850 | 0.707 | 0.860 | 0.860 |
| (wt. %) | | | | | | |
| FeO | 0.690 | 0.682 | 0.720 | 0.581 | 0.700 | 0.690 |
| (wt. %) | | | | | | |
| Fe⁺²/Feₜₒₜₐₗ | 94.32 | 93.57 | 94.14 | 91.33 | 90.46 | 89.17 |
| NiO | 0.145 | 0.017 | 0.061 | 0.043 | 0.026 | 0.090 |
| (wt. %) | | | | | | |
| CoO | 0.007 | 0.000 | 0.016 | 0.000 | 0.003 | 0.002 |
| (wt. %) | | | | | | |
| V₂O₅ | 0.216 | 0.220 | 0.052 | 0.050 | 0.053 | 0.052 |
| (wt. %) | | | | | | |
| TiO₂ | 1.51 | 1.50 | 0.00 | 0.00 | 0.00 | 0.00 |
| (wt. %) | | | | | | |
| SnO | 3.03 | 2.94 | 3.08 | 2.88 | 3.00 | 2.98 |
| (wt. %) | | | | | | |
| P₂O₅ | 0.00 | 0.00 | 2.12 | 1.95 | 2.09 | 2.14 |
| (wt %) | | | | | | |
| Flourine | 0.00 | 0.00 | 0.00 | 0.82 | 0.00 | 0.00 |
| (wt. %) | | | | | | |
| ZnO | 0.00 | 0.00 | 2.15 | 0.00 | 2.07 | 2.06 |
| (wt. %) | | | | | | |
| SO₃ | 0.060 | 0.060 | 0.058 | 0.060 | 0.53 | 0.059 |
| (wt. %) | | | | | | |
| Thickness | 3.3 | 4.0 | 3.42 | 3.3 | 3.42 | 3.402 |
| (mm) | | | | | | |
| Visible Trans- | 15.31 | 27.04 | 23.91 | 41.78 | 45.57 | 31.25 |
| mittance (%) | | | | | | |
| Solar Trans- | 6.43 | 8.38 | 11.35 | 16.51 | 18.08 | 12.28 |
| mittance (%) | | | | | | |
| Solar-IR | 3.32 | 2.27 | 3.11 | 5.10 | 3.21 | 2.73 |
| (%) | | | | | | |
| Solar-Visible | 9.54 | 14.41 | 18.94 | 27.48 | 32.07 | 21.16 |
| (%) | | | | | | |
| Solar-UV | 0.84 | 0.66 | 19.44 | 12.35 | 22.72 | 18.61 |
| (%) | | | | | | |
| L | 46.06 | 59.01 | 56.00 | 70.72 | 73.27 | 62.72 |
| a* | 0.41 | −9.24 | −18.61 | −7.04 | −18.66 | −13.30 |
| b* | 49.21 | 46.92 | −0.60 | 33.17 | 6.04 | 19.77 |
| x | 0.51 | 0.48 | 0.40 | 0.47 | 0.42 | 0.45 |
| Y | 0.46 | 0.47 | 0.44 | 0.45 | 0.44 | 0.45 |

Solar optical properties of selected solar-control glasses

Although only a few embodiments have been disclosed in detail above, other modifications are possible. Similar and significant reductions in the solar transmission and solar IR transmission of glass used for autos, trucks, houses and buildings can be obtained by the techniques disclosed in this invention—maximizing the total iron content and redox potential for a fixed visible transmission glass, adding P₂O₅ to further reduce solar IR transmission, adding NiO and CoO to alter the color characteristics, adding ZnO to eliminate sulfide inclusions, and adding TiO₂ or V₂O₅ to reduce UV transmission. Also, several other elements and compounds could be added to the glass (beyond the compounds Feo, Fe₂O₃ and SnO) to achieve a variety of different effects. Such effects include color changes, ease of meltability, viscosity enhancement, etc. Those skilled in the art will also recognize that there are ways to achieve the specified range of redox potential, other than the use of SnO.

What is claimed is:

1. A glass composition, comprising:
a glass matrix material; and
a first dopant, including Fe, added to said glass matrix material in an amount which increases a redox potential and effects an amount of solar transmission of the glass; and
at least one other dopant, added to said glass matrix material in an amount that does not change said amount of solar transmission, but changes at least one interaction between said first dopant and some other material.

2. The glass composition as in claim 1, wherein said first dopant is capable of existing in multiple valence states, and said at least one other dopant effects said valence state of said first dopant.

3. A composition as in claim 1, wherein said at least one other dopant changes a color of the glass without changing said amount of solar transmission of the glass.

4. A composition as in claim 1, wherein said at least one other dopant includes a Ni containing material at an amount less than 0.1 wt. percent.

5. A composition as in claim 3, wherein said one other dopant includes a Co containing material at an amount which is effective to impart blue coloration.

6. A composition as in claim 5, wherein said Co is included that an amount that is less than 0.03 wt. percent.

7. A composition as in claim 1, wherein said at least one other dopant includes vanadium.

8. A composition as in claim 7, wherein said vanadium is present at an amount effective to impart a green coloration.

9. A composition as in claim 2, wherein said at least one dopant includes titanium dioxide.

10. A composition as in claim 9, further comprising a fluorine dopant.

11. A composition as in claim 2, wherein said at least one other dopant includes NiO, and titanium dioxide.

12. A composition as in claim 1, wherein said at least one other dopant includes SnO and titanium dioxide.

13. A composition as in claim 1, wherein said at least one other dopant includes phosphorus.

14. A composition as in claim 13, wherein said phosphorus is present in the form of P₂O₅.

15. A composition as in claim 13, wherein said phosphorus is present in an amount effective to decolorize said Fe dopant.

16. A composition as in claim 13, further comprising an additional transition metal dopant.

17. A composition as in claim 14, wherein said phosphorus is provided in an amount less than 2 percent by weight.

18. A composition as in claim 14, wherein said first dopant includes 0.8 weight percent Fe₂O₃, and said second dopant includes 2 percent SnO.

19. A composition as in claim 1, wherein said at least one other dopant includes zinc.

20. A composition as in claim 19, wherein said zinc is present in the form of ZnO.

21. A composition as in claim 20, wherein said zinc is present at less than 2 wt. percent.

22. A composition as in claim 19, wherein said zinc is added in an amount effective to clarify the resulting composition by between four and five percent.

23. A composition as in claim 1, wherein said at least one other dopant includes all of Sn, P, Zn and V.

24. A composition as in claim 23, wherein said at least one other dopant also includes Ni.

25. A composition as in claim 23, wherein said at least one other dopant also includes Co.

26. A glass composition as in claim 1, wherein said materials and said dopants create a glass with a redox potential that is greater than or equal to 80 percent.

27. A glass composition as in claim 26, wherein said redox potential is greater than or equal to 85 percent.

28. A glass composition as in claim 26, wherein said redox potential is greater than or equal to 90 percent.

29. A glass composition as in claim 25, wherein said redox potential is greater than or equal to 95 percent.

30. A glass composition as in claim 26, further comprising addition of additional dopant materials which alter color transmission characteristics of a resulting glass.

31. A glass composition as in claim 31, wherein said color altering materials include CoO and NiO.

32. A glass composition, comprising:
a glass matrix material; and
a plurality of dopants, added to said glass matrix, including at least all of Fe₂O₃, SnO, P₂O₅, ZnO and V₂O₅.

33. A composition as in claim 32, wherein said dopants are added in an amount effective to produce a redox potential of at least 80 percent.

34. A composition as in claim 32, wherein said Fe₂O₃ is added at an amount between 0.5 and 1.0 wt. percent.

35. A composition as in claim 34, wherein said Fe₂O₃ is added at an amount of about 0.8 wt. percent.

36. A composition as in claim 32, further comprising additional dopants of NiO and CoO.

37. A composition as in claim 32, wherein said dopants are added in an amount effective to reduce solar IR transmission to an amount less than 6.6 percent.

38. A composition as in claim 36, wherein said NiO and CoO dopants are added in an amount effective to change a coloration of the glass by a desired amount.

39. A glass composition comprising:
a glass matrix material; and
a plurality of dopants added to said glass matrix material, including at least one transition metal, and one material which is effective to change a color of said transition metal,
said glass having a visible transmission between 15 and 27 percent, and a solar transmission <15%.

40. A glass as in claim 39, wherein said dopants are added in an amount which is effective to reduce solar IR transmissions to an amount less than 6.6 percent.

41. A glass as in claim 39, wherein said one material changes a color of the transition metal in said glass, without changing a solar transmission property of said glass.

42. A glass composition, comprising:
a glass matrix material;
an iron dopant, including at least a material of a metal oxide; and
a titanium dioxide dopant, also added to said glass matrix material, in an amount effective to change product coloration via interactions with said metal oxide.

43. A composition as in claim 42, wherein said metal oxide includes FeₓO_{y}.

44. A composition as in claim 42, wherein said metal oxide includes NiO.

45. A composition as in claim 42, further comprising a zinc material added in an amount that is effective to clarify the glass.

46. A composition as in claim 42, wherein said metal oxide includes SnO.

47. A composition as in claim 43, wherein said metal oxide includes Fe₂O₃.

48. A composition as in claim 42, further comprising materials producing a highly reducing condition with a redox of at least 80 percent.

49. A glass composition, comprising:
a glass matrix;
at least one Fe dopant, added in an amount which forms a highly reducing atmosphere and a total iron content between 0.6 wt. percent and 1 wt. percent;
at least one additional dopant including Sn, and
at least one other dopant, said at least one other dopant material added in an amount effective to reduce solar transmission to below 6.4 percent.

50. A glass composition as in claim 49, wherein said dopants are added in an amount effective to maintain a redox potential at greater than or equal to 80 percent.

51. A glass composition as in claim 49, wherein said dopants are added in an amount effective to maintain a redox potential at greater than or equal to 85 percent.

52. A glass composition as in claim 49, wherein said dopants are added in an amount effective to maintain a redox potential at greater than or equal to 90 percent.

53. A glass composition as in claim 49, wherein said dopants are added in an amount effective to maintain a redox potential at greater than or equal to 95 percent.

54. A glass composition as in claim 50, further comprising addition of first materials to alter color transmission characteristics.

55. A glass composition as in claim 54, wherein said first materials include CoO and NiO.

56. A glass having a transition metal dopant, and phosphorus in an amount effective to decolorize the transition metal dopant.

57. A glass composition as in claim 56, wherein said transition metal dopant includes Fe ions.

58. A glass composition as in claim 56, wherein said transition metal dopant includes Sn.

59. A glass composition as in claim 56, wherein said glass also includes a material which is effective to provide a reducing condition.

60. A glass composition as in claim 56, wherein said reducing condition material includes SnO.

61. A glass composition as in claim 56, wherein said SnO is added at 3%+/−1%.

62. A glass composition, comprising:
a glass matrix;
a plurality of dopants added to the matrix, including:
an iron dopant, added in an amount to produce a total iron amount between 0.7 in 0.9 wt. percent, and a ratio between Fe⁺⁺/Feₜₒₜₐₗ of greater than 80 percent,
an SnO dopant added at about 3 wt. percent;
a NiO and CoO dopant added in an amount effective to alter color characteristics; and
at least one of TiO₂ or V₂O₅ added in an amount effective to reduce ultraviolet transmission.

63. A composition as in claim 62, wherein both V₂O₅ and TiO₂ are added.

64. A composition as in claim 62, wherein said TiO₂ is added at about 1.5 wt. percent.

65. A composition as in claim 63, wherein said V₂O₅ is added at about 0.2 wt. percent.

66. A composition as in claim 62, wherein only V₂O₅ is added, at about 0.5 wt. percent

67. A composition as in claim 62, further comprising an additional dopant of P₂O₅ at about 2 wt. percent.

68. A glass composition, comprising:
glass matrix formed of a silicate material;
at least one first dopant, added to said silicate material and effective to reduce solar IR transmissions; and
at least one other dopant, added to said silicate material, to alter color characteristics of a glass that would otherwise be formed by said at least one first dopant being added to said glass matrix.

69. A composition as in claim 68, wherein said at least one other dopant includes CoO and NiO.

70. A composition as in claim 68, wherein said CoO is present at around 0.002 percent, and said NiO is present at about 0.09 percent.

71. A composition as in claim 68, wherein said at least one another dopant includes NiO.

72. A composition as in claim 68, wherein said NiO is present at an amount between 0.09 percent and 0.14 percent.

73. A composition as in claim 68, wherein said at least one other dopant is a dopant which increases redox potential.

74. A composition as in claim 68, wherein said at least other dopant is a dopant which includes Fe.

75. A composition as in claim 68, wherein said at least one other dopant is a dopant which includes SnO.

76. A method, comprising:
determining an ideal transmission curve based on a lowest theoretical solar transmission at any at least one specified visible transmittance; and
forming a glass that has characteristics that match within a specified percentage of said ideal transmission curve.

77. A method as in claim 77, wherein said specified percentage is 10%.

78. A method as in claim 77, wherein said specified percentage is 5%.

79. A method as in claim 77, further comprising matching a mean and sigma of said transmission curve to a specified range.

80. A method as in claim 77, wherein said forming comprises forming a glass that has characteristics that form a transmission curve between solar transmission and visible transmittance that has a shape that matches a shape of said ideal curve.

81. A glass, having a transmission curve expressed as:
$$T ( λ ) = exp [ - \frac{{( z - λ )}^{2}}{2 * {42.59}^{2}} ]$$
where z is between 557.49 and 569.72.

82. A glass which has a solar transmission which is within 5% of an optimal solar transmission for a specified visible transmittance.

83. A method comprising:
determining a theoretical minimum solar transmission for a specified glass at a specified visible transmittance; and
forming a glass manifesting a transmission spectra consistent with the presence of a single guassian peaked at wavelengths between 450 and 650 nm thereby imparting said glass with solar passing characteristics within a specified amount of said theoretical minimum.

84. A glass composition, comprising:
a glass matrix material; and
a plurality of dopants, added to the glass matrix material, which meet the relationship
$$- {t}^{- 1} log [ T ( λ ) ] = {\sum }_{i} {β}_{i} {c}_{i} + {\sum }_{i} {\sum }_{j} {β}_{ij} {c}_{i} {c}_{j}$$
where t is the thickness of the glass, T(λ) is a transmission at each wavelength, Cᵢ is a concentration of each primary dopant, Cⱼ is a concentration of each interactive dopant, and βᵢ and βᵢⱼ are least squares regression coefficients.

85. A glass as in claim 84, wherein a molar fraction of total iron present in its ferrous state, expressed as a ratio to total iron, is at least 80 percent.

86. A glass composition which has characteristics of solar transmittance and visible transmittances which are within a specified amount of an ideal transmission curve relating highest visible transmittance with lowest solar visible transmittances.

87. A composition as in claim 86 wherein said glass composition includes a silicate glass and plural dopants.

88. A composition as in claim 87, wherein at least one of said dopants are selected for interactions among the dopants.

89. A composition as in claim 88, wherein the glass includes primary dopants, which are one of FeₓO_{y}, e.g., Fe₂O₃, NiO, CoO, and V₂O₅.

90. A composition as in claim 89, wherein said dopants further include reducing agents.

91. A composition as in claim 89, wherein said dopants further include C, and metal sulfides.

92. A composition as in claim 91, wherein said interaction is a redox interactions among the primary dopants and the reducing agents.

93. A composition as in claim 89 wherein said interaction is a redox interaction among primary dopants themselves that exist in multiple valence states.

94. A composition as in claim 88, wherein said interaction is one which causes visible decolorization of other dopants.

95. A composition as in claim 89 wherein said interaction is one which changes color of one of said primary dopants.

96. A composition of claim 95 wherein an additional dopant includes one of fluorine and P₂O₅.

97. A composition as in claim 95, wherein an absorption spectrum is shifted by incorporation of high field strength cations (TiO₂) and the associated weakening in metal-ligand bonds of the primary dopants.

98. A composition as in claim 95, wherein said color change includes an optical clarification effect.

99. A composition as in claim 88, wherein said color change includes ZnO additions and these additions may prevent formation of other materials.

100. A composition as in claim 99, wherein said interaction is one which prevents formation of at least one other materials in the glass composition.

101. A composition as in claim 100, wherein said other materials include specified metal sulfides.

102. A composition as in claim 101, wherein said specified metal sulfide's include at least one of FeS and NiS.

103. A method comprising:
determining a glass composition; and
modeling characteristics of said glass composition at each of a plurality of wavelengths necessary for calculation of both solar and visible transmittances, said modeling comprising modeling the optical response for solar transmittance separate from the optical response for the visible transmittance at each of the plurality of wavelengths.

104. A method as in claim 103, further comprising determining an optimal transmission curve, and forming a glass that comes within a specified percentage of said optimal transmission curve.

105. A method as in claim 104, wherein said optimal transmission curve has a Gaussian shape.

106. A method as in claim 103 further comprising forming transmittance curves at each of the plurality of wavelengths, and calculating color coordinates from said transmittance curves.

107. A method as in claim 103, wherein said modeling characteristics comprises determining product coloration as a constraint.

108. A method as in claim 107, wherein said determining a glass composition comprises forming a glass matrix, forming at least one primary to open, and forming at least one secondary dopants.

109. A method as in claim 108, wherein NiO is one of said secondary dopants.

110. A method as in claim 108, wherein CoO is one of said secondary to open is added to add blue coloration to the glass composition.

111. A method as in claim 108, wherein V is one of the secondary dopants, added to provide infrared absorption characteristics.

112. A method as in claim 108, wherein said primary dopant includes a transition metal, and wherein Ti is added to color the transition metal.

113. A method as in claim 108, wherein said primary dopants includes Fe, and P is added to decolorize the primary dopant by stabilizing the state of the Fe.

114. A method as in claim 108, wherein said secondary dopant includes ZnO.

115. A glass composition comprising a glass matrix, having a redox potential in excess of 80%, SnO of between 2-4%, and total iron content between 0.6% and 1%.

116. A composition as in claim 115 further comprising P₂O₅ to further reduce solar IR transmission.

117. A composition as in claim 116, further comprising NiO and CoO to alter color characteristics.

118. A composition as in claim 116, further comprising ZnO to eliminate sulfide inclusions.

119. A composition as in claim 116, further comprising TiO₂ or V₂O₅ to reduce UV transmisison.

120. A composition of claim 114 wherein said secondary dopant with no substantial optical effect on the glass change the valence state of another dopant.

121. A composition of claim 114, further comprising the glass obeying a Gaussian of the form:
$$T ( λ ) = exp [ - \frac{{( z - λ )}^{2}}{2 * {42.59}^{2}} ]$$
where z is a value between 557.49 and 571.

122. A glass, including:
a glass matrix material including a plurality of dopants, which includes a first dopant that is capable of existing in a plurality of oxidation states, and a second dopant that causes said first dopant to exist, at least mostly, in one of said oxidation states.

123. A glass of claim 119, wherein said first dopant includes iron.

124. A glass matrix material including a plurality of dopants, which includes a first dopant that is capable of existing in a plurality of compounds, and a second dopant that prevents, at least mostly, said first dopant from forming said one of said compounds.

125. A glass as in claim 121, wherein said first dopant is Ni; and said second dopant is a dopant that prevents NiS formation.

126. A glass as in claim 121, wherein said second dopant is ZnO.

127. A glass matrix material including a plurality of dopants, which includes a first dopant that may cause specified coloration effects, and a second dopant that prevents at least part of said coloration effects.

128. A glass as in claim 124, wherein said first dopant is Fe.

129. A glass as in claim 124, wherein said second dopant is P₂O₅.

130. A glass as in claim 124, wherein said second dopant is one which has no substantial effects other than said coloration effect.

131. A glass as in claim 126, wherein said second dopant is ZnO, to prevent transition metal sulfides in glasses.

132. A glass composition, comprising:
a glass matrix material;
a primary dopant material, including a transition metal; and
at least one secondary dopant, said secondary dopant comprising a material which by itself has no effect, but which interacts with other dopants to change a characteristic of the glass.

133. A composition as in claim 132, wherein said secondary dopants include both NiO and ZnO, and wherein said ZnO is used to decolorize said NiO.
